(19) United States
(12) Patent Application Publication
(10) Pub. No.: US 2014/0073337 A1
(43) Pub. Date: Mar. 13, 2014

(54) COMMUNICATION DEVICE AND COMMUNICATION METHOD USING MILLIMETER-WAVE FREQUENCY BAND

(71) Applicant: Electronics and Telecommunications Research Institute, Daejeon (KR)

(72) Inventors: Seung Eun HONG, Daejeon (KR); Moon Sik LEE, Daejeon (KR); Young Seog SONG, Daejeon (KR); Jun Hwan LEE, Seoul (KR); Eun Young CHOI, Daejeon (KR); Il Gyu KIM, Chungcheongbuk-do (KR); Seung Chan BANG, Daejeon (KR)

(73) Assignee: Electronics and Telecommunications Research Institute, Daejeon (KR)

(21) Appl. No.: 14/023,050

(22) Filed: Sep. 10, 2013

(30) Foreign Application Priority Data
Sep. 11, 2012 (KR) 10-2012-0100581
Sep. 9, 2013 (KR) 10-2013-0107722

(51) Int. Cl. H04W 72/12

(52) U.S. Cl. CPC H04W 72/1231
USPC 455/452.1

(57) ABSTRACT

There are provided a communication device using a millimeter-wave frequency band and a communication method using the millimeter-wave frequency band. The communication device includes a beam scheduling unit configured to schedule uplink and downlink beams corresponding to movement of a terminal, a core network interface unit configured to transmit data provided from the beam scheduling unit to a core network, and to provide data received from the core network to the beam scheduling unit, a mobility management unit configured to configure an uplink and downlink beam set based on inter-beam interference information provided from the beam scheduling unit, and an inter-base station interface unit configured to exchange a control message with another base station under control of the mobility management unit. Therefore, it is possible to efficiently build a cellular network using the millimeter-wave frequency band.

### CLAIM FOR PRIORITY

This application claims priority to Korean Patent Application No. 10-2012-0100581 filed on Sep. 11, 2012 and No. 10-2013-0107722 filed on Sep. 9, 2013 in the Korean Intellectual Property Office (KIPO), the entire contents of which are hereby incorporated by reference.

### BACKGROUND

1. Technical Field

Example embodiments of the present invention relate to wireless communication technology, and more specifically, to a communication device and communication method using a millimeter-wave frequency band that can build a cellular network using the millimeter-wave frequency band.

2. Related Art

A long term evolution (LTE)-Advanced and a worldwide interoperability for microwave access (WiMAX) currently under way for 4G mobile communication system development are a system that uses a frequency band below 6 GHz, uses a maximum 100 MHz bandwidth in the frequency band, introduces various wireless technology such as 8×8 multiple-input multiple-output (MIMO), carrier aggregation (CA), coordinated multi-point transmission (CoMP), and relay, and tries to secure a maximum transmission capacity of 1 Gbps.

Meanwhile, according to mobile data usage forecasting of wired/wireless service providers including mobile communication carriers and traffic forecasting research organizations, it is expected that the mobile data usage is up to 1000 times as today's data usage in 2020. This is a quiet reasonable prediction when taking into consideration that a mobile data usage rate is gradually changed from conventional voice or text services to video services requiring a higher transmission rate, and a use of smart terminal such as a smartphone and tablet rather than conventional general cellular phones is exponentially increasing.

As described above, as traffic usage exponentially increases and frequency efficiency improvement in a current cellular frequency band meets its limits, a new method of building a cellular network that uses a millimeter-wave (mmWave) frequency band from 10 GHz to 300 GHz in which a wider bandwidth expansion is available is considered.

When the millimeter-wave frequency band is used in mobile communication, it is possible to obtain a wide bandwidth of 1 GHz or more. Moreover, beamforming technology necessary for communication using the millimeter-wave frequency band is applied in addition to directionality that is a physical propagation characteristic of signals having the millimeter-wave frequency band. Therefore, since space resources and wireless resources such as a time, frequency, and code may be used, it is possible to dramatically increase a wireless capacity.

Currently, as examples in which the millimeter-wave frequency band is used in wireless communication, there is a wireless personal area network (WPAN) system having a short range of about 10 m focusing on a 60 GHz frequency band, or a case of point-to-point communication for wireless backhaul in a 70 to 80 GHz band. However, up to now, a use of the millimeter-wave frequency band is limited to a specific field.

When the cellular network (or cellular mobile communication system) using the millimeter-wave frequency band is implemented, it is possible to satisfy explosively growing mobile traffic demands using wide bandwidth frequency resources and space resource recycling. Therefore, it is expected that next-generation application services such as an ultra-definition (UD) image service may be easily provided with high service quality.

However, up to now, since a specific method of building the cellular network using the millimeter-wave frequency band has not been proposed, it is necessary to provide the specific method in order to build the cellular network using the millimeter-wave frequency band.

### SUMMARY

Accordingly, example embodiments of the present invention are provided to substantially obviate one or more problems due to limitations and disadvantages of the related art.

Example embodiments of the present invention provide a communication device using a millimeter-wave frequency band for building a cellular network using the millimeter-wave frequency band.

Example embodiments of the present invention also provide a communication method using the millimeter-wave frequency band that can be applied in the cellular network using the millimeter-wave frequency band.

The present invention is not limited to above example embodiments. Example embodiments not described may be precisely understood by those skilled in the art from the following descriptions.

In some example embodiments, a wireless communication device using a millimeter-wave frequency band includes a beam scheduling unit configured to schedule uplink and downlink beams corresponding to movement of a terminal, a core network interface unit configured to transmit data provided from the beam scheduling unit to a core network, and to provide data received from the core network to the beam scheduling unit, a mobility management unit configured to configure an uplink and downlink beam set based on inter-beam interference information provided from the beam scheduling unit, and an inter-base station interface unit configured to exchange a control message with another base station under control of the mobility management unit.

The beam scheduling unit may include a central scheduler and at least one beam scheduler connected to the central scheduler, the central scheduler may distribute packets input from the core network through the core network interface unit to the at least one beam scheduler, schedule the packets provided from the at least one beam scheduler, and transmit the packets to the core network through the core network interface unit, and the at least one beam scheduler may schedule based on scheduling information provided from the central scheduler.

The at least one beam scheduler may receive location information of at least one terminal from the at least one terminal, report the received location information of the at least one terminal to the central scheduler, and then schedule resources for the at least one terminal based on scheduling information provided from the central scheduler.

The central scheduler may obtain information on a terminal located in an inter-beam overlapping area based on the location information of the at least one terminal, and schedule based on the obtained terminal information such that inter-beam interference is minimized.

When at least two base stations cooperate to transmit downlink packets to the terminal, the central scheduler may schedule a transmission time of packets, and then transmit scheduling information to the at least one beam scheduler and another base station.

The mobility management unit may configure a measurement beam set to be measured by the terminal based on location information of the terminal provided from the beam scheduling unit, and report the configured measurement beam set information to the terminal.

The mobility management unit may determine a cooperated beam set that provides downlink beams to the terminal based on the inter-beam interference information.

The mobility management unit may compare a candidate cooperated beam set provided by the terminal and a pre-stored candidate cooperated beam set, determine a change of the candidate cooperated beam set, and then, when there is a deleted beam in the pre-stored candidate cooperated set, request deletion of resources associated with the deleted beam from a base station that forms the deleted beam.

The mobility management unit may obtain round-trip time information obtained through terminal uplink synchronization operations from at least one other base station through the inter-base station interface unit, and determine a cooperated beam set for uplink transmission of the terminal based on the obtained round-trip time information.

In other example embodiments, a wireless communication device using a millimeter-wave frequency band includes a beam scheduling unit configured to schedule a beam for accessing of a terminal, a wireless backhaul interface unit configured to communicate with least one other base station under control of the beam scheduling unit, and a mobility management unit configured to deliver information provided from the terminal to another base station through the wireless backhaul interface unit.

The beam scheduling unit may include a central scheduler and at least one beam scheduler connected to the central scheduler, the central scheduler may control scheduling of the at least one beam scheduler, and the at least one beam scheduling unit may respectively provide an access beam for at least one terminal under control of the central scheduler.

The mobility management unit may receive location information from at least one terminal, and deliver the information to another base station through the wireless backhaul interface unit.

The mobility management unit may deliver information on a downlink candidate cooperated beam set provided from at least one terminal to another base station through the wireless backhaul interface unit, and deliver round-trip time values of the at least one terminal to the another base station.

In still other example embodiments, a wireless communication method using a millimeter-wave frequency band includes obtaining location information of at least one terminal, obtaining information on a terminal located in an inter-beam overlapping area based on the obtained location information, and scheduling based on information on the terminal located in the obtained inter-beam overlapping area such that inter-beam interference is minimized.

In the obtaining of location information of the at least one terminal, beam identifier information for at least one beam that can be received by the at least one terminal may be respectively received from the at least one terminal.

In the obtaining of location information of the at least one terminal, inter-beam interference information may be received from the at least one terminal.

In the scheduling for minimizing the inter-beam interference, different frequency bands may be assigned to an overlapping beam area and a non-overlapping beam area in consideration of the inter-beam overlapping area, and a frequency band assigned to the overlapping beam area may be changed according to location of at least one terminal and resource allocation information of the at least one terminal.

In yet other example embodiments, a wireless communication method using a millimeter-wave frequency band that is performed in a terminal using the millimeter-wave frequency band, includes registering transmitting and receiving capability information in a base station, measuring received power of each beam included in a beam set based on information on the beam set provided from the base station, updating a downlink candidate cooperated beam set based on the received power measurement result of each beam, and then reporting the updated downlink candidate cooperated beam set to the base station, and performing uplink synchronization based on a downlink active cooperated beam set provided from the base station.

In the registering of the transmitting and receiving capability information in the base station, information on the number of beams that can be simultaneously received by the terminal and the number of beams that can be simultaneously transmitted from the terminal may be reported to the base station.

The performing of the uplink synchronization may include setting the downlink active cooperated beam set provided from the base station as an uplink active cooperated beam set, and performing uplink synchronization for beams included in the uplink active cooperated beam set.

### BRIEF DESCRIPTION OF DRAWINGS

Example embodiments of the present invention will become more apparent by describing in detail example embodiments of the present invention with reference to the accompanying drawings, in which:

Example embodiments of the present invention will become more apparent by describing in detail example embodiments of the present invention with reference to the accompanying drawings, in which:

FIGS. 1 and 2 are conceptual diagrams illustrating an example of an antenna applied in a communication system according to an embodiment of the invention.

FIGS. 3 and 4 are conceptual diagrams illustrating a method of removing a side lobe of a horn antenna.

FIGS. 5 and 6 are conceptual diagrams illustrating a plurality of beam patterns provided by a base station including the antenna according to the embodiment of the invention.

FIGS. 7 and 8 are conceptual diagrams illustrating the plurality of beam patterns provided by the base station including the antenna in a vertical and horizontal direction according to the embodiment of the invention.

FIGS. 9 and 10 are conceptual diagrams illustrating another example of the antenna applied in the communication system according to the embodiment of the invention.

FIG. 11 is a conceptual diagram illustrating a shadowing environment that can occur in a cellular network in which a communication system using a millimeter-wave frequency is applied.

FIG. 12 is a conceptual diagram illustrating a configuration of the communication system according to the embodiment of the invention.

FIG. 13 is a conceptual diagram illustrating an example of an antenna applied in a relay base station according to the embodiment of the invention.

FIG. 14 is a conceptual diagram illustrating an example of an antenna applied in a terminal according to an embodiment of the invention.

FIG. 15 is a block diagram illustrating a configuration of a beamforming device in which analog beamforming technology and digital beamforming technology are combined.

FIG. 16 is a block diagram illustrating a configuration of a central base station according to the embodiment of the invention.

FIG. 17 is a flowchart illustrating operations of a beam scheduling unit of the central base station illustrated in FIG. 16.

FIG. 18 is a conceptual diagram illustrating an interference minimizing scheduling method performed in the communication system using the millimeter-wave frequency band according to the embodiment of the invention.

FIG. 19 is a block diagram illustrating a configuration of the relay base station according to the embodiment of the invention.

FIG. 20 is a conceptual diagram illustrating hierarchical hybrid scheduling of the central base station and the relay base station in a wireless communication system using the millimeter-wave frequency band according to the embodiment of the invention.

FIG. 21 is a conceptual diagram illustrating a handover method that is performed in the wireless communication system using the millimeter-wave frequency band according to the embodiment of the invention.

FIG. 22 is a conceptual diagram illustrating the handover method in more detail that is performed in the wireless communication system using the millimeter-wave frequency band according to the embodiment of the invention.

FIG. 23 is a flowchart illustrating the handover method that is performed in the wireless communication system using the millimeter-wave frequency band according to the embodiment of the invention.

FIGS. 24A and 24B are sequence diagrams illustrating the handover method that is performed in the wireless communication system using the millimeter-wave frequency band according to the embodiment of the invention.

FIG. 25 is a conceptual diagram illustrating an example of a multi-mode multi-access method that can be applied in the wireless communication system using the millimeter-wave frequency band according to the embodiment of the invention.

### DESCRIPTION OF EXAMPLE EMBODIMENTS

While the invention can be modified in various ways and take on various alternative forms, specific embodiments thereof are shown in the drawings and described in detail below as examples.

There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent; however, the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, exemplary embodiments of the invention will be described in detail with reference to the accompanying drawings. Elements that appear in more than one drawing or are mentioned in more than one place in the detailed description will be consistently denoted by the same respective reference numerals and described in detail no more than once.

Embodiments of the invention described below may be supported by standard documents disclosed in at least one of Institute of Electrical and Electronics Engineers (IEEE) 802 system, 3rd generation partnership project (3GPP) system, 3GPP LTE system, and 3GPP2 system, which are wireless access systems. That is, in order to clearly disclose the technological scope of the invention, operations or parts not described in the embodiments of the invention may be supported by the standard documents. Moreover, all terms used herein may be explained by the standard documents.

The term “terminal” used in the present specification may refer to a mobile station (MS), user equipment (UE), machine type communication (MTC) device, mobile terminal (MT), user terminal (UT), wireless terminal, access terminal (AT), subscriber unit, subscriber station (SS), wireless device, wireless communication device, wireless transmit/receive unit (WTRU), mobile node, mobile, or other terminals.

The term “base station” used herein refers to a control device that controls one cell. However, a physical base station in an actual wireless communication system can control a plurality of cells. In this case, the physical base station may include one or more base stations used herein. For example, a parameter that is differently assigned to each cell in this specification will be understood that each base station assigns a different value. The term “base station” may also be referred to as a base station, node-B, eNode-B, base transceiver system (BTS), access point, and transmission point.

In order to build a cellular network using a millimeter-wave frequency band, it is necessary to address a high path loss problem due to a high frequency and a shadowing problem due to radio signal obstructions related to directionality of radio signals, and to efficiently support a mobile station (MS) while a wide service area (coverage) is provided.

In order to overcome a high path loss, that is propagation characteristics of signals having a millimeter-wave frequency band, it is necessary to obtain a high transmitting and receiving antenna gain in consideration of a limited transmitting and receiving power use. This requirement may be regarded as a feature of a communication system using a millimeter-wave frequency differentiated from conventional cellular mobile communication systems.

In general, in order to form a single transmitting/receiving beam, a plurality of antennas are necessary. This is because, as the number of antennas increases, a width of a formed transmitting/receiving beam decreases generally, which results in a high antenna gain.

Meanwhile, since a beam formed by the plurality of antennas delivers a signal only in a predetermined specific direction, in order to transmit the signal toward a wide area, it is necessary to form multiple mutually-different beams and transmit the signal in different directions other than the specific direction. In this case, it is possible to deliver the signal using the same frequency resource at the same time.

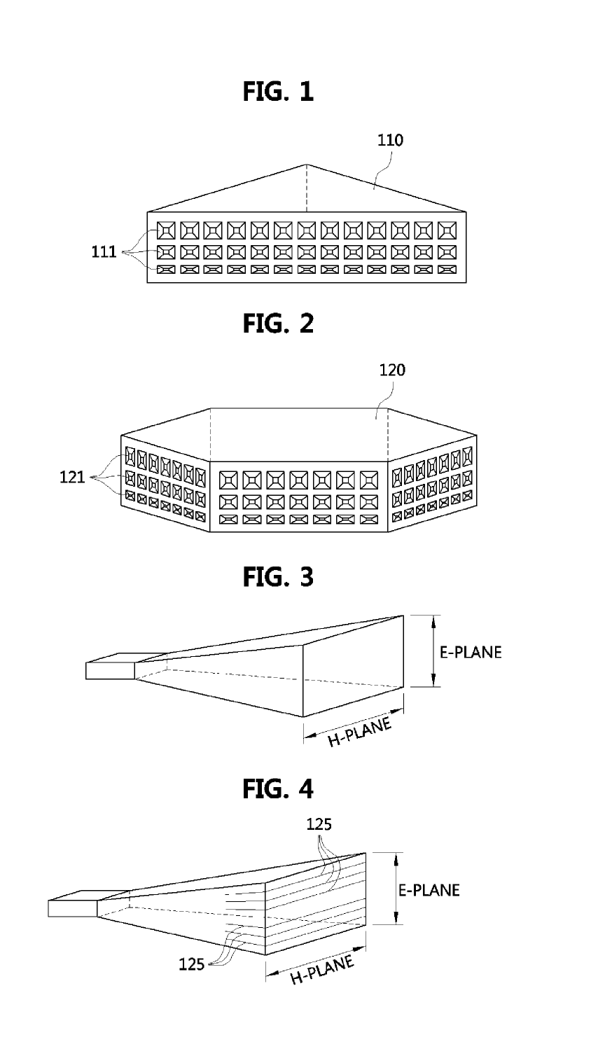

FIGS. 1 and 2 are conceptual diagrams illustrating an example of an antenna applied in a communication system according to an embodiment of the invention.

The antennas illustrated in FIGS. 1 and 2 are designed to overcome a limitation due to characteristics of a signal using the millimeter-wave frequency, and to maximize an advantage of the signal using the millimeter-wave frequency. The antennas may be applied to a base station in a cellular network using the millimeter-wave frequency.

As illustrated in FIGS. 1 and 2, FIG. 1 illustrates a shape of an antenna 110 that includes three surfaces each responsible for 120 degrees and supports all cells. FIG. 2 illustrates a shape of an antenna 120 that includes six surfaces each responsible for 60 degrees and supports all cells.

First, as illustrated in FIG. 1, the antenna 110 according to the embodiment of the invention may have a cross section having a triangular shape, a plurality of antenna elements 111 are provided in each surface, and each surface is responsible for 120 degrees of a service area.

More specifically, the antenna elements 111 configuring each surface may be arranged in rows and columns. For example, as illustrated in FIG. 1, the antenna elements 111 configuring each surface may be arranged in 3 rows and 12 columns and each of the antenna elements 111 may form an individual beam.

The beam formed by each of the antenna elements 111 may also adjust a beamforming direction using an adjustment value (for example, an antenna adjustment parameter) of the antenna 110. However, for convenience of description, it is described that a direction of the beam formed by each of the antenna elements 111 is fixed in the embodiment of the invention.

On the other hand, when the direction of the beam formed by each of the antenna elements 111 can be adjusted, various well-known technology may be applied to adjust the direction of the beam formed by each of the antenna elements 111. For example, it is possible to include an additional digital circuit for adjusting the direction of the beam formed by each of the antenna elements 111.

However, when the direction of the beam formed by each of the antenna elements 111 is fixed in a predetermined direction, an additional component for adjusting the direction of the beam is unnecessary so that it is possible to implement the antenna 110 simply. That is, when it is configured such that the direction of the beam formed by each of the antenna elements 111 is fixed, since the additional circuit for adjusting the direction of the beam is unnecessary, it is possible to implement the antenna 110 relatively simply.

Referring to FIG. 1 again, the antenna 110 according to the embodiment of the invention may be configured such that a horizontal angle and a vertical angle of the beam formed by each of the antenna elements 111 configuring each surface of the antenna 110 are fixed in a predetermined angle. For example, the horizontal angle of the beam formed by each antenna element 111 may be fixed at 10 degrees. Moreover, it may be configured such that the vertical angle of the beam formed by each antenna element 111 has a different angle according to the row in which the antenna element 111 is arranged. For example, the vertical angle of the beam formed by each antenna element 111 may have 10 degrees for antenna elements included in a first row, 30 degrees for antenna elements included in a second row, and 50 degrees for antenna elements included in a third row from above of each surface.

Therefore, in order for one surface of the antenna 110 to support an area of 120 degrees horizontally, 12 antenna elements provided in each row may be arranged such that a center of a horizontal angle thereof is respectively separated by 10 degrees. Here, the angle of the beam formed by each antenna element 111 provided in each row may be differently formed according to the number of antenna elements 111 provided in each row and other factors (for example, the number of surfaces of the antenna 110 or a coverage angle of one side of the antenna 110). Here, the angle of the beam of each antenna element 111 is an angle represented based on a half power beam width (HPBW).

On the other hand, as illustrated in FIG. 2, the antenna 120 according to another embodiment of the invention has a cross section having a hexagonal shape, and a plurality of antenna elements 121 are provided in each surface thereof, and each surface is responsible for 60 degrees of a service area.

More specifically, the antenna elements 121 configuring each surface may be arranged in 3 rows and 6 columns. Each row includes 6 antenna elements, and each surface includes 18 antenna elements 121 in total. Like the antenna elements 111 illustrated in FIG. 1, a horizontal angle of a beam formed by each of the antenna elements 121 provided in each row may be fixed at 10 degrees. Further, like the antenna elements 111 illustrated in FIG. 1, a vertical angle of the beam formed by each of the antenna elements 121 may have 10 degrees for antenna elements included in a first row, 30 degrees for antenna elements included in a second row, and 50 degrees for antenna elements included in a third row from above of each surface.

The conceptual diagrams of the antennas according to the embodiments of the invention illustrated in FIGS. 1 and 2 illustrate the antennas having a triangular-shaped cross section and a hexagonal-shaped cross section as examples. However, the technological scope of the invention is not limited to exemplified antenna structures in FIGS. 1 and 2. That is, an overall shape of the antenna, arrangement of antenna elements configuring each surface of the antenna, the number of antenna elements, and the horizontal and vertical angles of the beam formed by each of the antenna elements can be variously changed according to an environment in which the antenna is provided.

Moreover, each antenna element illustrated in FIGS. 1 and 2 may be implemented as an antenna element having various shapes. For example, each antenna element may be implemented as a horn antenna or a patch array antenna (PAA). Here, in order to improve an antenna gain of each antenna element, it is necessary to reduce a beam width formed by each antenna element. For this purpose, a method of increasing a size of the horn antenna may be used for the horn antenna, and a method of increasing the number of patch array antenna elements having a half-wavelength interval may be used for the patch array antenna.

For example, when each antenna element is configured as the horn antenna, a size of E-plane and H-plane of each horn antenna provided in a first row of each surface of the antenna is respectively set to about 5.7 cm and 8 cm, a size of E-plane and H-plane of each horn antenna provided in a second row is respectively set to about 1.9 cm and 7.9 cm, and a size of E-plane and H-plane of each horn antenna provided in a third row is respectively set to about 1.3 cm and 7.9 cm.

The horn antenna provides a higher antenna gain than the patch array antenna and outputs high power of several Watts. However, when the horn antenna is used, a side lobe is largely formed in a vertical direction.

FIGS. 3 and 4 are conceptual diagrams illustrating a method of removing the side lobe of the horn antenna. FIG. 3 illustrates a structure of a general horn antenna, and FIG. 4 illustrates a structure of a horn antenna having non-uniformed slots formed therein.

In order to reduce a ratio of a side lobe with respect to a main lobe in the horn antenna to 20 dB or less, as illustrated in FIG. 4, non-uniformed slots 125 may be formed in an aperture of the horn antenna. In this case, the sizes of E-plane and H-plane of the horn may be slightly increased.

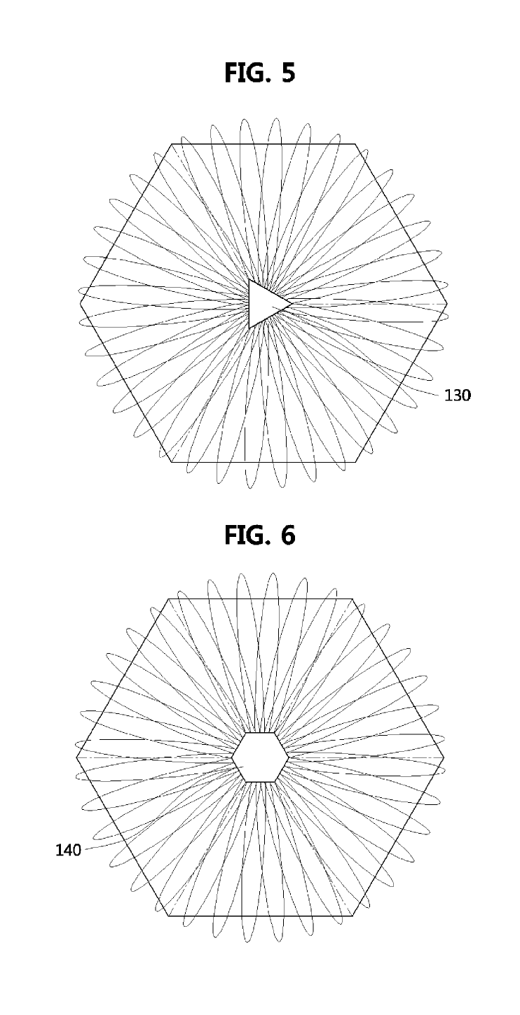

FIGS. 5 and 6 are conceptual diagrams illustrating a plurality of beam patterns provided by a base station including the antenna according to the embodiment of the invention. FIG. 5 illustrates a beam pattern provided by a base station including the antenna 130 having the shape illustrated in FIG. 1. FIG. 6 illustrates a beam pattern provided by a base station including the antenna 140 having the shape illustrated in FIG. 2.

As illustrated in FIGS. 5 and 6, according to the invention, the base station configures the antennas 130 and 140 to have a different shape according to the number of cells to which the base station provides a service and a form thereof, and antenna elements are arranged in each surface of the antennas 130 and 140 so that it is possible to form a beam in all directions.

That is, as illustrated in FIG. 5, when a service area of the base station is configured with three cells, as illustrated in FIG. 1, the antenna 130 is configured to have a triangular shape, and a plurality of antenna elements (for example, 12 elements), which form a beam width having a predetermined horizontal angle (for example, 10 degrees), are arranged in each surface so that it is possible for each surface of the antenna 130 to cover 120 degrees in a horizontal direction.

Alternatively, as illustrated in FIG. 6, when the service area of the base station is configured with six cells, as illustrated in FIG. 2, the antenna 140 is configured to have a hexagonal shape, and a plurality of antenna elements (for example, 6 elements), which form a beam width having a predetermined horizontal angle (for example, 10 degrees), are arranged in each surface so that it is possible for each surface of the antenna 140 to cover 60 degrees in a horizontal direction.

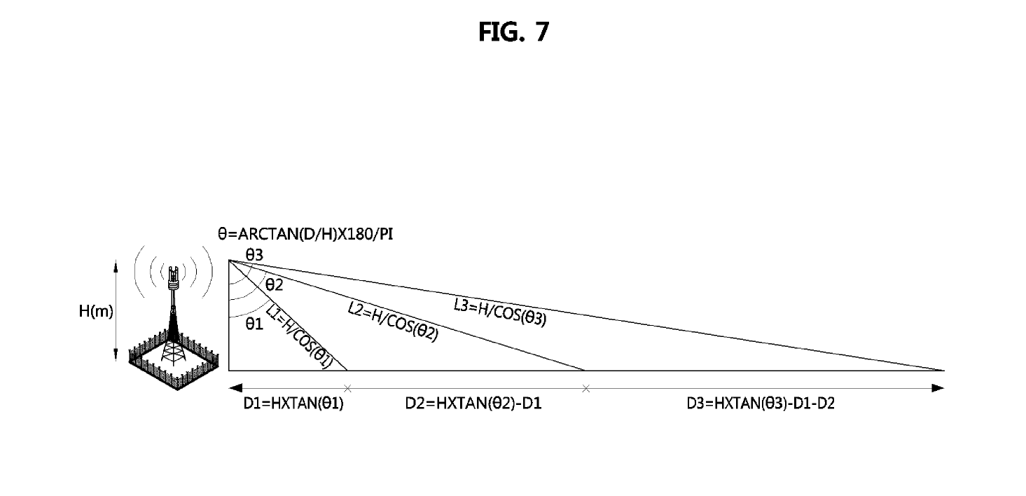

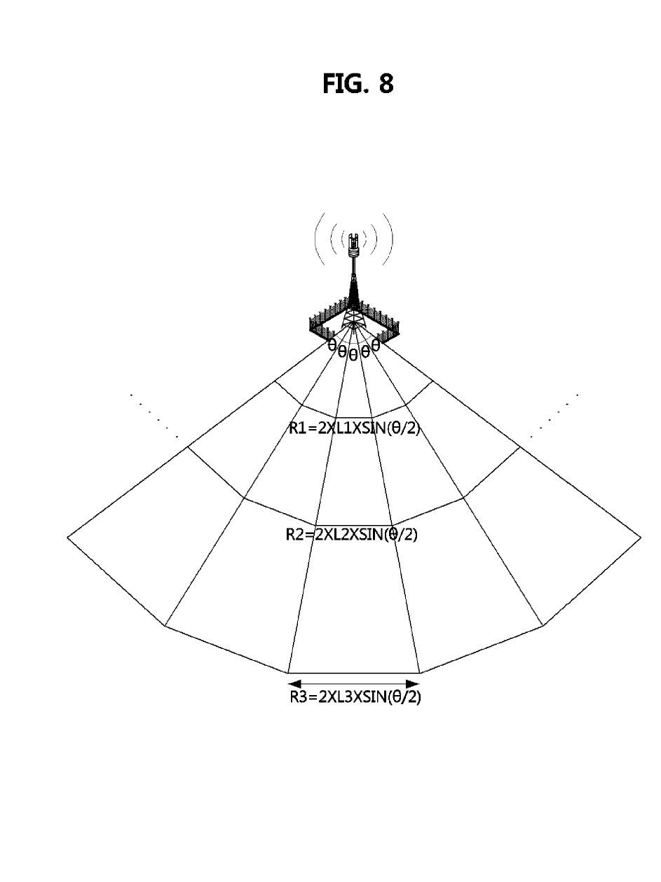

FIGS. 7 and 8 are conceptual diagrams illustrating the plurality of beam patterns provided by the base station including the antenna in a vertical and horizontal direction according to the embodiment of the invention. FIG. 7 illustrates three beam patterns formed by three antenna elements configuring one column among the plurality of antenna elements configuring one surface of the antenna illustrated in FIG. 1. FIG. 8 illustrates a beam pattern formed by antenna elements configuring one surface of the antenna illustrated in FIG. 1.

In FIG. 7, H represents a height of the antenna, and θ1 represents a vertical angle of a beam formed by one antenna element provided in a third row from above among the antenna elements arranged in one surface of the antenna illustrated in FIG. 1. θ2 represents an angle that is a sum of vertical angles of beams formed by two antenna elements provided in a third row and in a second row from above among three antenna elements configuring one column in the antenna illustrated in FIG. 1. θ3 is an angle that is a sum of vertical angles of beams formed by three antenna elements configuring one column in the antenna illustrated in FIG. 1.

D1, D2, and D3 respectively represent coverage (that is, a ground distance covered by a beam) of beams formed by a third, second, and first antenna element from above among three antenna elements configuring one column in the antenna illustrated in FIG. 1. Here, D1, D2, and D3 may be calculated by Equation 1.

D1=H×tan(θ₁)

D2=H×tan(θ₂)−D1

D3=H×tan(θ₃)−D1−D2 Equation 1

L1, L2, and L3 respectively represent distances from the antenna to maximum ground points at which three beams respectively formed by a third, second, and first antennas from above among antenna elements included in a specific column in the antenna illustrated in FIG. 1 arrive. L1, L2, and L3 may be calculated by Equation 2.

L1=H/cos(θ₁)

L2=H/cos(θ₂)

L3=H/cos(θ₃) Equation 2

Meanwhile, in FIG. 8, θ represents a horizontal angle of a beam formed by each antenna element configuring the antenna illustrated in FIG. 1. R1 represents horizontal is coverage (that is, a distance provided by a horizontal angle in vertical coverage of a corresponding beam) of a beam formed by an antenna element provided in a third row from above among three beams formed by three antenna elements included in a specific column among antenna elements configuring the antenna illustrated in FIG. 1. R2 represents horizontal coverage of a beam formed by an antenna element provided in a second row from above among three beams formed by three antenna elements included in a specific column among antenna elements configuring the antenna illustrated in FIG. 1. R3 represents horizontal coverage of a beam formed by an antenna element provided in a first row from above among three beams formed by three antenna elements included in a specific column among antenna elements configuring the antenna illustrated in FIGS. 1.

R1, R2, and R3 may be calculated by Equation 3.

R1=2×L1×sin(θ/2)

R2=2×L2×sin(θ/2)

R3=2×L3×sin(θ/2) Equation 3

In FIGS. 7 and 8, an angle and coverage of a beam are calculated based on HPBW.

In the above-described antennas according to the embodiments of the invention, a case in which a horn antenna structure is used to implement multiple beams respectively formed in a fixed direction has been described as an example.

However, the technological scope of the invention also includes an antenna array structure for implementing adaptive beamforming such as massive MIMO. For example, when a cell to which the base station provides a service includes N sectors, in order to provide the service to each sector, the base station may include a patch array antenna having a plurality of antenna elements corresponding to each sector, and the patch array antenna may be configured to simultaneously form a plurality of beams using digital beamforming technology.

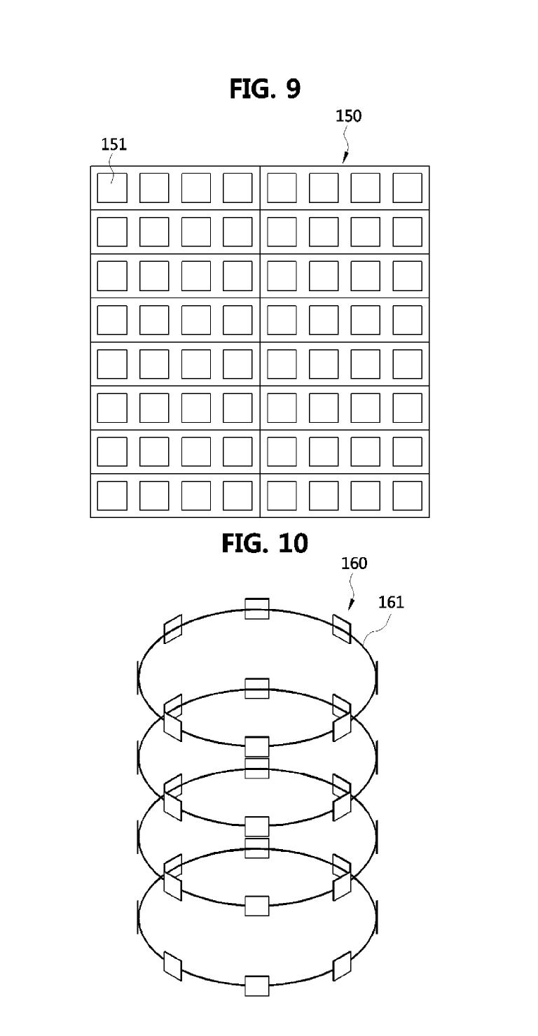

FIGS. 9 and 10 are conceptual diagrams illustrating another example of the antenna applied in the communication system according to the embodiment of the invention.

As illustrated in FIGS. 9 and 10, the patch array antenna may have a structure in which an antenna array module having a certain number of antenna elements is extended. For example, as illustrated in FIG. 9, a 1×N linear antenna array module 151 is extended to a P×Q planar antenna array to configure a patch array antenna 150.

Alternatively, as illustrated in FIG. 10, a 1×N circular antenna array module 161 is extended to a P×N circular antenna array to configure a patch array antenna 160.

Structures of the patch array antennas 150 and 160 illustrated in FIGS. 9 and 10 illustrate an example of the antenna structure that can be applied in the communication system using the millimeter-wave frequency band according to the embodiment of the invention. The antenna structure that can be applied in the communication system of the invention is not limited to the structures of the patch array antennas 150 and 160 illustrated in FIGS. 9 and 10. When the antenna can provide a plurality of beams in a predetermined service area, regardless of a type and/or structure thereof, it is deemed that the antenna is included in the technological scope of the invention.

Meanwhile, as propagation characteristics of signals having the millimeter-wave frequency band, there are disadvantages in, for example, a high path loss due to a high frequency component and a higher path loss than a frequency band used in a cellular communication system due to signal attenuation caused by air or water molecules as describe above, and signals are likely to be obstructed by buildings or obstacles due to propagation directionality.

Therefore, in a cellular network using the millimeter-wave frequency, it is necessary to address a shadowing problem due to blocking of line of sight (LOS) caused by, for example, buildings or obstacles.

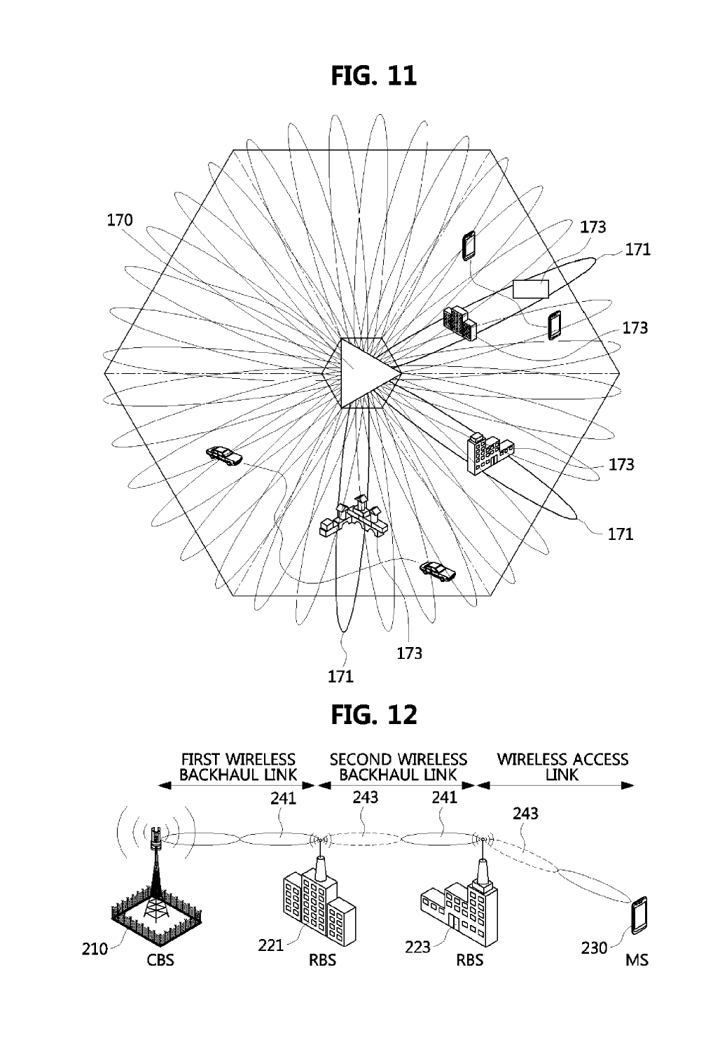

FIG. 11 is a conceptual diagram illustrating a shadowing environment that can occur in the cellular network in which the communication system using the millimeter-wave frequency is applied.

As illustrated in FIG. 11, at least one beam 171 among a plurality of beams generated from an antenna 170 provided in the base station may be blocked by, for example, a building 173 or an obstacle 173.

In other words, when the building 173 or obstacle 173 is located in a propagation path of the beam 171 generated from the base station, propagation of the beam is blocked due to the building or obstacle so that a shadowing phenomenon in which signals are not delivered to a desired location is generated.

The shadowing phenomenon due to obstacles as described above may be addressed using a relay device. In particular, the shadowing phenomenon may be serious in an urban environment in which buildings are densely located. Accordingly, in order to address the shadowing phenomenon, a use of a plurality relay devices may be necessary.

According to an implementation level of a layer function such as a RF, physical layer, MAC layer, and network layer, the relay device may be divided into a layer 0, layer 1, layer 2, and layer 3 relay device.

The layer 0 and layer 1 relay device receive a signal from the base station or another relay device, amplify the received signal, and transmit the amplified signal to another device. When the received signal is amplified, a noise and/or interference signal included in the received signal is amplified together, which results in a low signal transmission efficiency.

Due to the above disadvantage of the layer 0 and layer 1 relay device, the communication system according to the embodiment of the invention does not use the layer 0 and layer 1 relay device, but uses the layer 2 or more relay device to address the shadowing phenomenon. However, it does not mean that the layer 0 and layer 1 relay device may not be used in the communication system according to the embodiment of the invention. According to the communication environment, the layer 0 and layer 1 relay device may also be used.

FIG. 12 is a conceptual diagram illustrating a configuration of the communication system according to the embodiment of the invention, and illustrates a method of addressing the shadowing phenomenon using the relay device.

As illustrated in FIG. 12, the communication system using the millimeter-wave frequency band according to the embodiment of the invention may include a central base station (CBS) 210 that performs a function of the base station and at least one relay base station (RBS) 221 and 223 that performs a function of the relay device. A beam is connected using the central base station 210 and the at least one relay base station 221 and 223 so that it is possible to address the shadowing problem.

Hereinafter, in the embodiment of the invention, according to a wireless link between the central base station 210 and the relay base stations 221 and 223 or a beam level (or hop count) that connects the wireless link between the central base station 210 and the relay base stations 221 and 223, it is sequentially called a first wireless backhaul link, second wireless backhaul link, and nth wireless backhaul link. Moreover, a wireless link between a mobile station 230 and a relay base station or central base station to which the mobile station 230 is directly connected is called a wireless access link.

Among beams transmitted from each of the relay base stations 221 and 223, a beam in an uplink direction is called a wireless backhaul beam 241, and a beam in a downlink direction is called a wireless access beam 243.

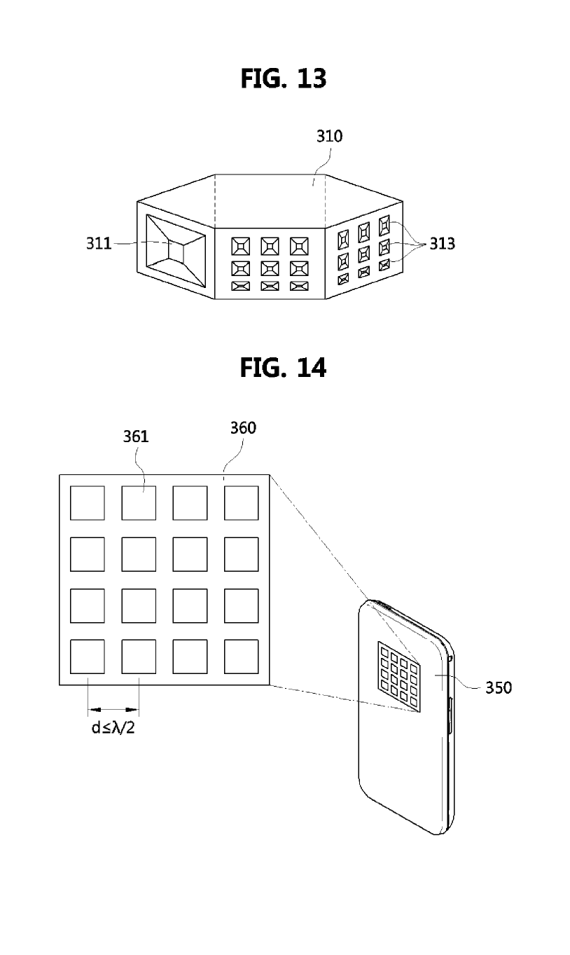

FIG. 13 is a conceptual diagram illustrating an example of an antenna applied in the relay base station according to the embodiment of the invention.

An antenna 310 provided in the relay base station may include an antenna element 311 for the wireless backhaul link that is used to connect a beam to the central base station or an upper relay base station, and a plurality of antenna elements 313 that are used to form a beam toward a lower relay base station or a terminal.

That is, as illustrated in FIG. 13, the antenna 310 for the relay base station may have a shape of a hexagonal pillar having a hexagonal cross section, and include six surfaces. The antenna element 311 may be provided in at least one surface (for example, a surface facing the central base station or upper relay base station) among the six surfaces in order to generate a wireless backhaul link with the central base station or upper relay base station. The antenna element 311 may be configured to have a high antenna gain.

Among the six surfaces, the plurality of antenna elements 313 for connecting a beam with at least one terminal or a lower relay base station may be provided in surfaces other than the surface in which the antenna element is provided to generate the wireless backhaul link.

Details of the antenna 310 illustrated in FIG. 13 are similar to those of FIGS. 1 and 2, and thus the detailed description thereof will not be repeated.

Meanwhile, the antenna for the relay base station may be implemented as a horn antenna or patch array antenna type.

The relay base station may form a wireless backhaul beam and a plurality of wireless access beams. In order to avoid interference between the wireless backhaul beam and wireless access beam, the relay device using a conventional cellular frequency band uses a method in which different frequencies are used in the wireless backhaul beam and wireless access beam or the wireless backhaul beam and wireless access beam are separated in time. However, since the relay base stations according to the embodiment of the invention use the millimeter-wave band frequency and use beamforming technology for concentrating signals in a specific direction, even when the same frequency and time resources are simultaneously used, it is possible to maintain very low interference between the wireless backhaul link and wireless access link.

FIG. 14 is a conceptual diagram illustrating an example of an antenna applied in a terminal according to an embodiment of the invention.

A terminal 350 provided with a service in the communication system using the millimeter-wave frequency band according to the embodiment of the invention may not use the horn antenna applied in the central base station or relay base station due to a limited form-factor and a limited power usage.

Therefore, the terminal 350 according to the embodiment of the invention may use a patch array antenna 360. The patch array antenna 360 may be variously configured according to a determined form-factor.

That is, as illustrated in FIG. 14, the patch array antenna 360 is provided in a front and/or rear side of the terminal 350 to configure a switched antenna type. Here, it may be configured such that a separation distance (d) between patch antenna elements 361 is more than a half-wavelength (λ/2).

Meanwhile, when the patch array antenna 360 is applied in the terminal 350, in order to address a problem in which an antenna gain decreases as a beam steering angle increases, the patch array antenna may also be provided in a left and right side of the terminal 350.

Moreover, in order to form a plurality of beams using the patch array antenna 360 illustrated in FIG. 14, general digital beamforming technology may be applied. That is, in order to apply digital beamforming technology, a separate RF chain is provided for each patch antenna element 361 configuring the patch array antenna 360, a direction of arrival (DOA) of signals received through each RF chain is extracted in a digital signal processing end of the terminal, and then digital signal processing (for example, Precoding or Postcoding) is performed based on the extracted DOA of signals so that it is possible to form multiple transmitting/receiving beams in a specific direction.

However, digital beamforming has problems in that the RF chain (or transceiver) for each antenna element of the patch array antenna is necessary and a complicated operation such as fine adjustment between antenna paths is necessary. In order to address these problems of digital beamforming technology, RF beamforming technology may be applied to implement a low power and low cost terminal.

However, RF beamforming technology has a problem in that only one transmitting/receiving beam may be formed using the plurality of antenna elements. In order to address the problem of RF beamforming technology, patch array antenna elements are divided into several groups, RF beamforming technology is applied for each group, and multiple beams equaling the number of antenna element groups may be formed.

Alternatively, hybrid type beamforming technology may also be used by taking advantages of digital beamforming technology and RF beamforming technology to form multiple beams. That is, a structure in which an array coefficient is primarily generated in an analog band the same as in conventional RF beamforming technology and an array coefficient is secondarily generated in a digital band using decreased transceivers due to a sub-array is used to form multiple beams while the number of transceivers decreases.

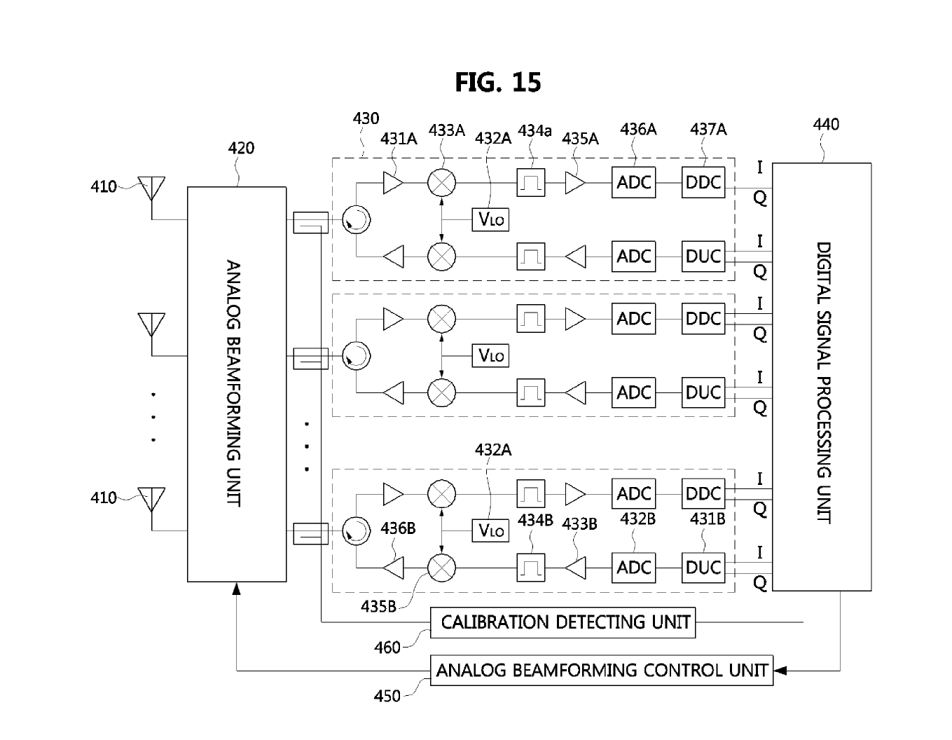

FIG. 15 is a block diagram illustrating a configuration of a beamforming device in which analog beamforming technology and digital beamforming technology are combined.

As illustrated in FIG. 15, the beamforming device includes, an analog beamforming unit 420 that is connected to a plurality of antennas 410 and performs beamforming by combining the plurality of antennas 410 based on a beamforming control signal provided from an analog beamforming control unit 450, a plurality of RF signal processing units 430 that is connected to the analog beamforming unit 420, processes a signal provided from the analog beamforming unit 420 and provides the signal to a digital signal processing unit 440, and processes a signal provided from the digital signal processing unit 440 and provides the signal to the analog beamforming unit 420, the digital signal processing unit 440 that performs digital signal processing to form a plurality of beams based on data provided from the plurality of RF signal processing units 430, and transmits a control signal for forming the plurality of beams to the analog beamforming control unit 450, the analog beamforming control unit 450 that provides a beamforming control signal for forming the plurality of beams to the analog beamforming unit 420 based on the control signal provided from the digital signal processing unit 440, and a calibration detecting unit 460 that is positioned between the analog beamforming unit 420 and the digital signal processing unit 440, detects a signal for beam calibration from the signal provided from the analog beamforming unit 420, and then provides the detected signal to the digital signal processing unit 440.

Meanwhile, each of the plurality of RF signal processing units 430 may include a receiver and a transmitter. Each receiver may include, a low noise amplifier (LNA) 431a that performs low noise amplification for a received signal, a mixer 433a that mixes the low noise amplified signal and a reference signal provided from a local oscillator 432a, a band pass filter (BPF) 434a that filters the signal output from the mixer 433a, an intermediate frequency amplifier (IF amplifier) 435a that amplifies the signal output from the band pass filter 434a, an analog-to-digital converter (ADC) 436a that converts the signal output from the intermediate frequency amplifier 435a to a digital signal, and a digital down converter (DDC) 437a that performs digital down converting for the digital signal output from the analog-to-digital converter 436a.

The transmitter included in each of the plurality of RF signal processing units 430 may include, a digital up converter (DUC) 431b that performs digital up converting for a signal provided from the digital signal processing unit 440, a digital-to-analog converter (DAC) 432b that converts a digital signal output from the digital up converter 431b to an analog signal, an intermediate frequency amplifier 433b that amplifies the signal output from the digital-to-analog converter 432b, a band pass filter 434b that performs band pass filtering for the signal output from the intermediate frequency amplifier 433b, a mixer 435b that mixes the signal output from the band pass filter 434b and the signal output from the local oscillator 432a, and an amplifier 436b that amplifies the signal output from the mixer 435b.

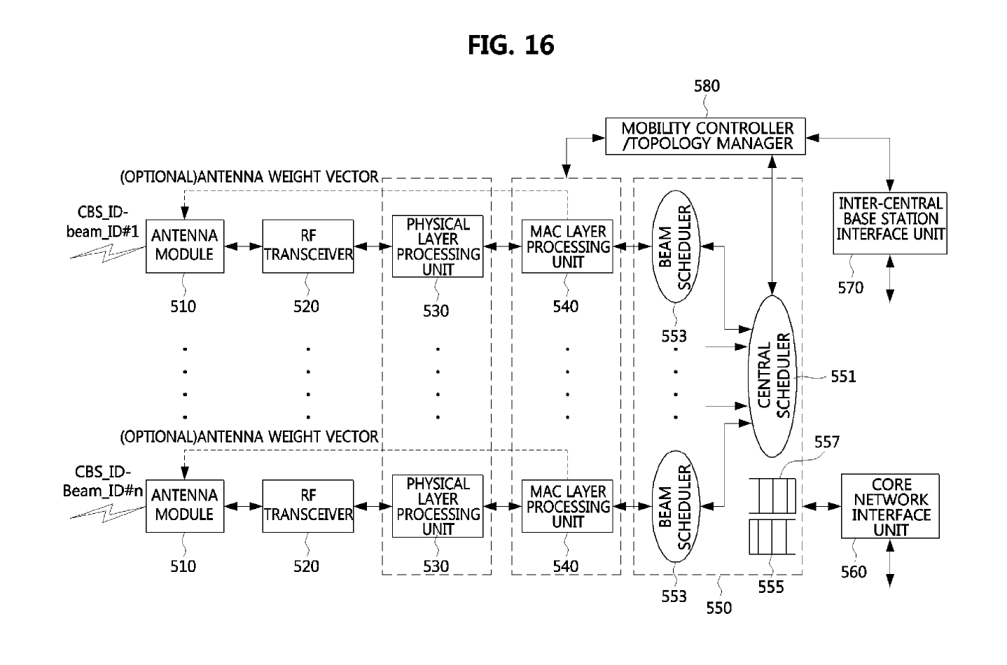

FIG. 16 is a block diagram illustrating a configuration of the central base station according to the embodiment of the invention.

As illustrated in FIG. 16, the central base station according to the embodiment of the invention may include a plurality of antenna modules 510, a plurality of RF transceivers 520, a physical layer processing unit 530, a MAC layer processing unit 540, a beam scheduling unit 550, a core network interface unit 560, an inter-central base station interface unit 570, and a mobility controller/topology manager 580.

Each of the plurality of antenna modules 510 may correspond to each antenna element in the antennas illustrated in FIGS. 1 and 2. Each antenna module 510 may form one beam and provide a service to the relay base station or terminal located in a beamforming area.

Each antenna module 510 may be implemented as the horn antenna or patch array antenna type. Here, when each antenna module 510 is implemented as the patch array antenna, a component (for example, the MAC layer processing unit) that performs digital signal processing sets a phase and/or amplitude of antenna elements configuring the patch array antenna to determine a beamforming direction.

The RF transceiver 520 is a component that performs the same function as the RF signal processing unit 430 in FIG. 15, and performs processing for transmitting and receiving a signal through the antenna module 510.

The physical layer processing unit 530 performs general physical layer functions, for example, coding, decoding, modulation, demodulation, multi-antenna mapping, and wireless resources mapping.

The MAC layer processing unit 540 performs general MAC layer functions, for example, channel multiplexing and retransmission. Moreover, the MAC layer processing unit 540 selectively provides an antenna weight vector value to each antenna module 510 so that it is possible to adjust beamforming and the beamforming direction.

The beam scheduling unit 550 includes a central scheduler 551 and a plurality of beam schedulers 553 connected to the central scheduler 551, and may perform two steps of scheduling. Here, the number of beam schedulers 553 may be equal to the number of antenna modules 510.

More specifically, each beam scheduler 553 performs uplink and downlink beam scheduling for each antenna module 510, and reports a load on the beam for which its own scheduler is responsible to the central scheduler 551.

Further, when scheduling information is provided from the central scheduler 551, each beam scheduler 553 performs scheduling based on the provided scheduling information.

The central scheduler 551 classifies packets input from a core network through the core network interface unit 560, and distributes the packets to the plurality of beam schedulers 553. Moreover, the central scheduler 551 performs scheduling for the packets output from each beam scheduler 553, and sequentially transmits the packets to the core network through the core network interface unit 560.

In particular, in consideration of overlapping of signal transmission areas in case of mutually-adjacent beams, the central scheduler 551 controls lower beam schedulers 553 and performs scheduling such that interference of terminals located in a beam overlapping area is minimized.

In order to perform the above-described functions, the beam scheduling unit 550 may use an input queue 555 and an output queue 557. Here, one input queue 555 and one output queue 557 may be included, or a plurality of input queues 555 and output queues 557 may be included to be used for differentiated queuing or scheduling based on a predetermined priority.

Furthermore, when at least two or more base stations among the central base station and the plurality of relay base stations cooperate and transmit a downlink packet to the terminal, the central scheduler 551 schedules a transmission time of transmission packets, and then reports scheduling information to the lower beam scheduler 553 and another relay base station participating in cooperated transmission of the downlink packet. Accordingly, it is possible to adjust a data transmission time.

The core network interface unit 560 performs communication between the core network and the central base station. That is, the core network interface unit 560 performs a function of exchanging data and/or control messages between the beam scheduling unit 550 of the central base station and the core network.

The inter-central base station interface unit 570 performs a function of communicating with another central base station. That is, the inter-central base station interface unit 570 exchanges data and/or control messages with another central base station, and provides the exchanged data and/or control messages to the mobility controller/topology manager 580.

Based on location information of the terminal, the mobility controller/topology manager 580 may configure a measurement beam set to be measured by the terminal with respect to the terminal location, and may report configured measurement beam set information to the terminal.

Moreover, based on interference information between beams provided from the terminal through the beam scheduling unit 550, the mobility controller/topology manager 580 may determine a downlink cooperated beam set that substantially provides downlink beams to the terminal.

The mobility controller/topology manager 580 receives information on a downlink candidate cooperated beam set from the terminal, compares the received information with pre-stored information on a downlink candidate cooperated beam set, and checks a change of the downlink candidate cooperated beam set based on a comparison result. Here, when there is a deleted beam in the downlink candidate cooperated beam set, the mobility controller/topology manager 580 requests deletion of resources associated with the terminal from a central base station and/or relay base stations forming a corresponding beam. When there is a newly added beam in the downlink candidate cooperated beam set, it is queried whether the terminal is accommodated to a mobility controller/topology manager of a corresponding central base station and/or relay base station.

In addition, the mobility controller/topology manager 580 receives a report of round-trip time values obtained through an uplink synchronization operation of the terminal from the mobility controller/topology manager of another central base station and/or relay base station, and configures a cooperated beam set for uplink transmission of the terminal from an uplink candidate cooperated beam set based on the reported round-trip time values.

In FIG. 16, the physical layer processing unit 530 and the MAC layer processing unit 540 may be configured to correspond to the number of antenna modules 510, or may be respectively configured as one component. However, as a wide bandwidth of the millimeter-wave frequency band is used, one beam formed by the central base station requires a very high data processing rate. Therefore, it is preferable that the physical layer processing unit 530 and the MAC layer processing unit 540 be implemented for each beam.

For example, when it is assumed that a channel bandwidth is 1 GHz, a channel cod rate is ⅚, a modulation scheme is 64 quadrature amplitude modulation (QAM), and control information overhead is ⅕, a data transmission rate provided for each beam is about 4 Gbps. As illustrated in FIG. 1, when a sector covers 120 degrees, and each sector provides 36 beams in total, it is possible to provide 144 Gbps/sector capacity.

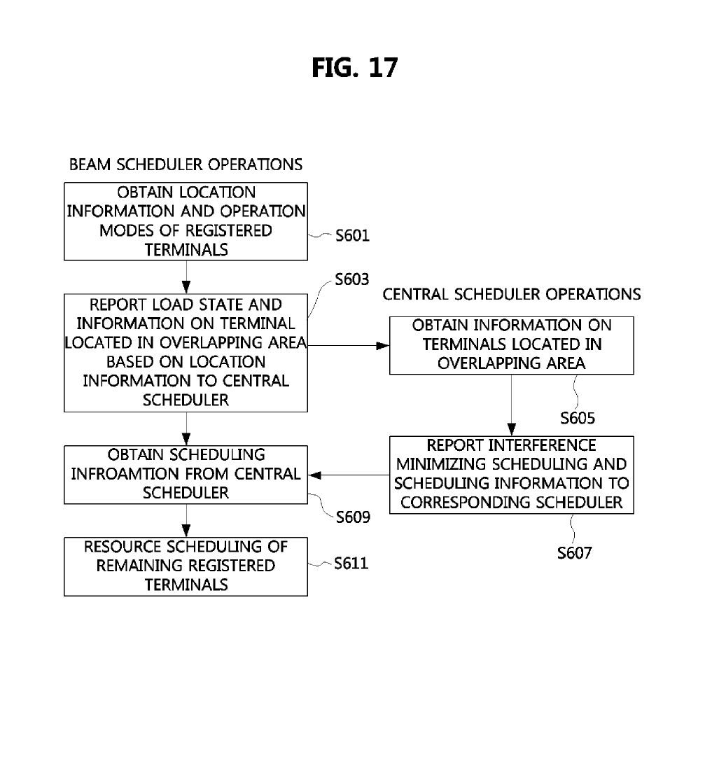

FIG. 17 is a flowchart illustrating operations of the beam scheduling unit of the central base station illustrated in FIG. 16, and exemplifies operation methods of each of the beam scheduler and central scheduler provided in the central base station.

As illustrated in FIG. 17, first, each beam scheduler obtains location information and operation modes of registered terminals (S601). Here, each beam scheduler may obtain location information of each terminal based on information to which beam information that can be received is fed back in addition to the beam registered by each terminal. To this end, the embodiment of the invention assigns a beam identifier that can identify a plurality of beams transmitted from the central base station to each beam.

Beam identifier information is unique beam identification information assigned to each beam in order to distinguish a predetermined beam from another beam. The beam identifier information is used to distinguish the predetermined beam from another beam, and is also used to easily determine whether the predetermined beam belongs to which central base station or relay base station.

The beam identifier may be configured by various methods. For example, when the communication system using the millimeter-wave frequency band according to the embodiment of the invention uses a frame structure similar to a frame used in a WiMAX system, it is possible to configure the beam identifier information using a frame preamble pattern. Alternatively, when the invention uses a frame structure similar to a frame of an LTE system, it is possible to configure the beam identifier information using a primary synchronization signal (PSS) and secondary synchronization signal (SSS) pattern. The invention does not designate a specific method. As described above, the beam identifier refers to unique information for identifying each beam, and the technological scope of the invention is not limited to a specific method of generating the beam identifier.

Meanwhile, each terminal feedbacks the beam information that can be received to a corresponding beam scheduler, and also selectively reports information on a frequency and/or time interval in which interference occurs to the beam scheduler. In this case, the interference information may be reported together when the beam information is reported, or may be reported only when the interference is detected.

In the cellular network using the millimeter-wave frequency band, interference may occur when a signal transmitted through a specific beam is reflected to another beam area by a building due to frequency characteristics, and beam interference may occur when the plurality of relay base stations transmit beams in a distributed beam structure. Therefore, the embodiment of the invention allows the terminal to feedback the above interference information to the beam scheduler so that it is possible to minimize interference.

Referring to FIG. 17 again, the beam scheduler that obtains the above information from the terminal reports load state information and/or terminal information located in an overlapping area of beams based on terminal location information to the central scheduler (S603).

The central scheduler obtains information on terminals belonging to the overlapping area from each of the lower beam schedulers (S605).

Then, based on information obtained from each beam scheduler, the central scheduler performs scheduling to minimize interference between beams that are provided to corresponding specific terminals located in the overlapping area (S607). Then, as described above, the central scheduler reports the scheduling information to each beam scheduler.

Each beam scheduler obtains the scheduling information of the terminals belonging to the beam overlapping area from the central scheduler (S609), and performs resource scheduling of remaining registered terminals with respect to the remaining wireless resources (S611). That is, beam schedulers located in a lower layer of the central scheduler schedules resources for unscheduled registered terminals based on the scheduling information obtained from the central scheduler. Here, the beam scheduler and central scheduler may schedule with reference to the interference information reported from the terminal to avoid interference.

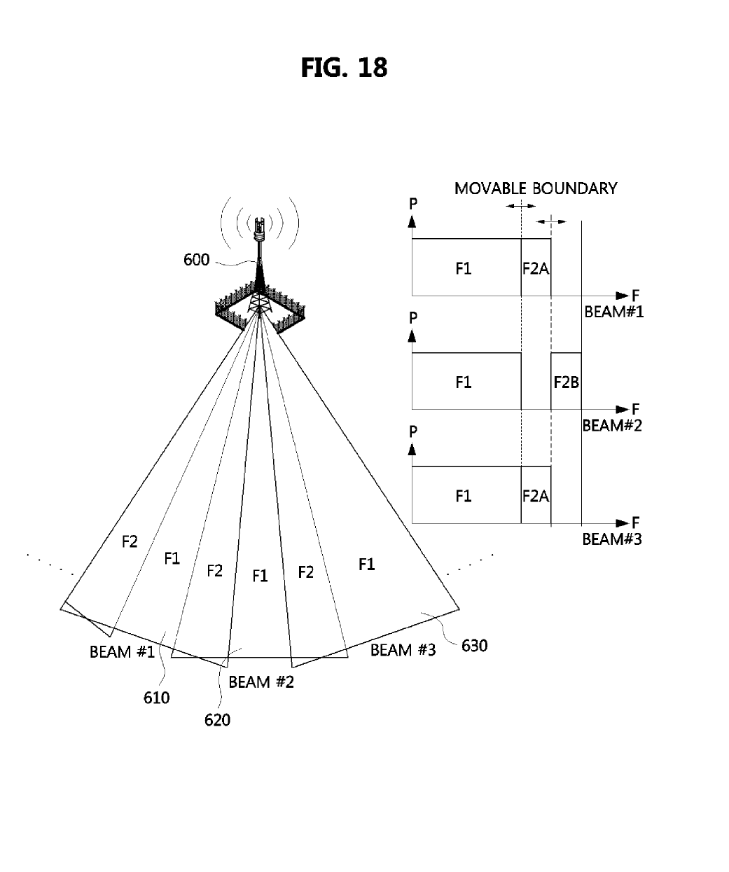

FIG. 18 is a conceptual diagram illustrating an interference minimizing scheduling method performed in the communication system using the millimeter-wave frequency band according to the embodiment of the invention.

As illustrated in FIG. 18, in the communication system using the millimeter-wave frequency band according to the embodiment of the invention, it may be considered to use a frame structure of an OFDMA method such as WiMAX and LTE.

When the frame structure of the OFDMA method is used, it is basically efficient for all beams to use the same frequency channel in terms of a frequency usage. However, an interference problem may occur in an overlapping area between beams due to a same frequency usage.

As a method of addressing the interference problem in the beam overlapping area within the same base station, a frequency band is divided into a frequency band to be used in the beam overlapping area and a frequency band to be used in a non-overlapping area, the frequency band to be used in the non-overlapping area is independently scheduled for each beam in the non-overlapping area, and the frequency band assigned to the overlapping area is divided again for overlapping beams in the beam overlapping area and it is scheduled such that only a frequency band assigned for each beam is used.

According to the invention, the central scheduler and the lower beam schedulers are connected to perform hierarchical scheduling, and the central scheduler and the beam schedulers are implemented to be included in the same device such that the central scheduler and the beam scheduler interchange terminal location and resource allocation information in real time. Therefore, since frequency resources can be adaptively divided according to the terminal location and a traffic load state, it is possible to prevent an inefficient resource usage problem due to a fixed frequency resource division.

For example, as illustrated in FIG. 18, when one central base station forms a first beam 610, a second beam 620, and a third beam 630, and a boundary of each beam overlaps, a central base station 600 may use a method in which a frequency is adaptively assigned in order to avoid interference between beams.

That is, the central base station 600 assigns a first frequency band F1 to a central area of the first beam (Beam#1) 610, the second beam (Beam#2) 620, and the third beam (Beam#3) 630, assigns second frequency bands F2A and F2B to a beam boundary area in which each beam overlaps, and determines a frequency band to be assigned for each beam in the second frequency band in consideration of the beam overlapping area. When the frequency band is assigned in this way, a reuse factor is 1 for the first frequency band and 2 for the second frequency band.

For example, the central base station assigns the second frequency band F2A to a non-overlapping left-side beam boundary area in the first beam 610, assigns the second frequency band F2B, that is not overlapped with F2A, to an overlapping area between the first and second beams 610 and 620, and assigns F2A again to an overlapping area between the second and third beams 620 and 630. Therefore, it is possible to avoid interference in beam overlapping areas.

According to the invention, as illustrated in FIG. 18, after the terminal location and resource allocation information is obtained in real time, the frequency band assigned to the beam overlapping area is adjusted according to the obtained information. Accordingly, it is possible to improve wireless resource usage efficiency.

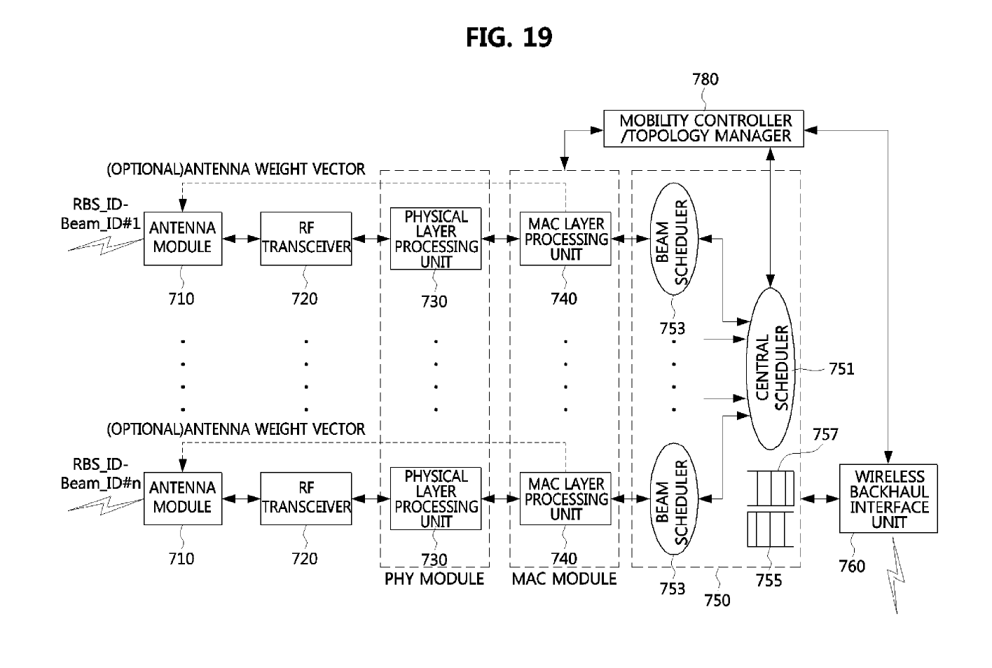

FIG. 19 is a block diagram illustrating a configuration of the relay base station according to the embodiment of the invention.

As illustrated in FIG. 19, the relay base station according to the embodiment of the invention may include a plurality of antenna modules 710, a plurality of RF transceivers 720, a physical layer processing unit 730, a MAC layer processing unit 740, a beam scheduling unit 750, a wireless backhaul interface unit 760, and a mobility controller/topology manager 2780.

As illustrated in FIG. 19, the relay base station according to the embodiment of the invention has a similar configuration as the central base station illustrated in FIG. 16. However, according to characteristics of the relay base station, instead of the core network interface unit 560 and the inter-central base station interface unit 570 which are provided in the central base station, the relay base station includes the wireless backhaul interface unit 760 configured to communicate with the upper relay base station or the central base station.

Since the plurality of antenna modules 710, the plurality of RF transceivers 720, the physical layer processing unit 730, and the MAC layer processing unit 740 illustrated in FIG. 19 perform the same functions as the plurality of antenna modules 510, the plurality of RF transceivers 720, the physical layer processing unit 730, and the MAC layer processing unit 740 illustrated in FIG. 11, the detailed description thereof will not be repeated.

The beam scheduling unit 750 may include a plurality of beam schedulers 753 for each access beam provided from the relay base station and a central scheduler 751 that can adjust scheduling of the beam schedulers 753. In this case, the plurality of beam schedulers 753 and/or the central scheduler 751 may support differentiated queuing/scheduling based on a packet priority. To this end, an input queue 755 and an output queue 757 may be used.

The wireless backhaul interface unit 760 is configured to connect a wireless backhaul link with another relay base station or the central base station, and exchange data and/or control signals with the other relay base station or the central base station.

The mobility controller/topology manager 780 is configured to deliver location information provided from the terminal to another upper relay base station or the central base station through the wireless backhaul interface unit 760.

Furthermore, the mobility controller/topology manager 780 receives information on a downlink candidate cooperated beam set from the terminal, and delivers the information to the other upper relay base station or the central base station. When deletion of resources allocated to the terminal associated with a specific beam is requested from the mobility controller/topology manager 580 of the central base station, the mobility controller/topology manager 780 delivers the request to the MAC layer processing unit 740.

In addition, when a message for querying whether the terminal is accommodated with respect to a newly added beam in the downlink cooperated beam set is received from the mobility controller/topology manager 580 of the central base station, the mobility controller/topology manager 780 provides a response thereof to a corresponding central base station.

Moreover, the mobility controller/topology manager 780 delivers the round-trip time values obtained by the uplink synchronization operation of the terminal to the upper relay base station or the central base station through the wireless backhaul interface unit 760.

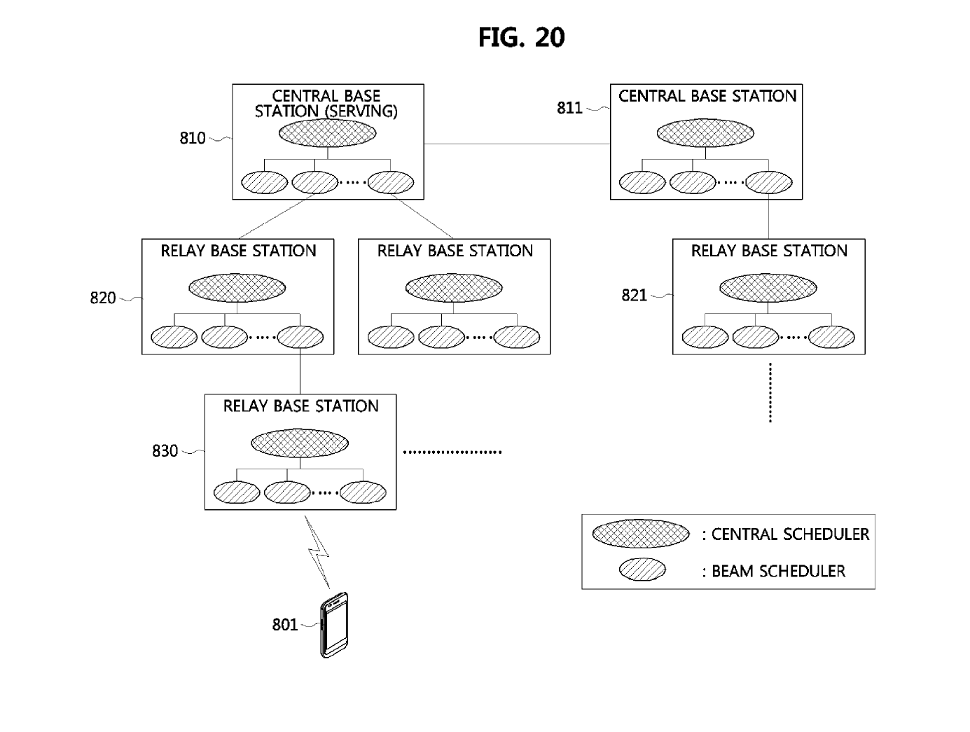

FIG. 20 is a conceptual diagram illustrating hierarchical hybrid scheduling of the central base station and the relay base station in the wireless communication system using the millimeter-wave frequency band according to the embodiment of the invention.

As illustrated in FIG. 20, in the wireless communication system using the millimeter-wave frequency band according to the embodiment of the invention, multi-level relay base stations are used to address the shadowing problem due to millimeter-wave frequency band characteristics, and it is assumed that each relay base station performs layer 2 or more relay functions in order to address a problem in which a noise and interference component are amplified in a signal transmission operation of the relay base station.

Moreover, in the embodiment of the invention, wireless links configuring a multi-hop may have different channel states. In order to address a problem in which channel state information of all terminals is delivered in real time through the wireless backhaul link, it is proposed that the relay base station performs its own scheduling function. However, in case of downlink transmission in the invention, it is configured such that scheduling is hierarchically performed in terms of a topology, scheduling information of the upper central base station or relay base station is naturally delivered to schedulers of lower relay base stations. Therefore, a centralized scheduling function is performed on only limited number of terminals or sessions.

For example, as illustrated in FIG. 20, when downlink traffic of a specific terminal 801 is provided to the terminal 801 through one or more relay base stations 820 and 830 from to a central base station 810, the central base station 810 schedules multi-hop links from the central base station 810 to the terminal, and delivers the traffic to schedulers of the lower relay base stations 820 and 830. The lower schedulers provided in each of the relay base stations 820 and 830 configuring each multi-hop link may perform scheduling according to upper scheduling information.

As described above, a hierarchical hybrid scheduling function may be applied in the invention which includes a distributed scheduling structure in which independent scheduling of the relay base stations is possible, and a centralized scheduling structure in which scheduling of the central base station selectively has a higher priority than scheduling of the relay base station.

That is, the centralized scheduling structure includes a master scheduler and slave schedulers. In general, a central scheduler of the central base station serves as a master. The centralized scheduling structure of the hierarchical hybrid scheduling may also be applied to schedulers of an adjacent central base station and schedulers of its lower relay base stations. In this case, a serving central base station scheduler in which a corresponding terminal is registered serves as a scheduling master. Here, the serving central base station is called “head CBS.”

As illustrated in FIG. 20, when the serving central base station 810 for the terminal 801 performs hierarchical hybrid scheduling, the serving central base station (or head CBS) 810 receives information necessary for scheduling from an adjacent central base station 811, and schedules downlink traffic for the terminal 801. In this case, the adjacent central base station 811 receives necessary information from relay base stations 821 located in a lower layer thereof and provides the information to the serving central base station 810.

In the wireless communication system using the millimeter-wave frequency band according to the embodiment of the invention, as described above, it is possible to perform joint processing (JP) transmission in a coordinated multi-point (COMP) transmission method in LTE advanced using hierarchical hybrid scheduling between the central base station and relay base stations. To this end, it is possible to obtain timing synchronization in multiple transmission points (or central and/or relay base station). Here, a method of obtaining timing synchronization among multiple transmission points may be performed using well-known technology.

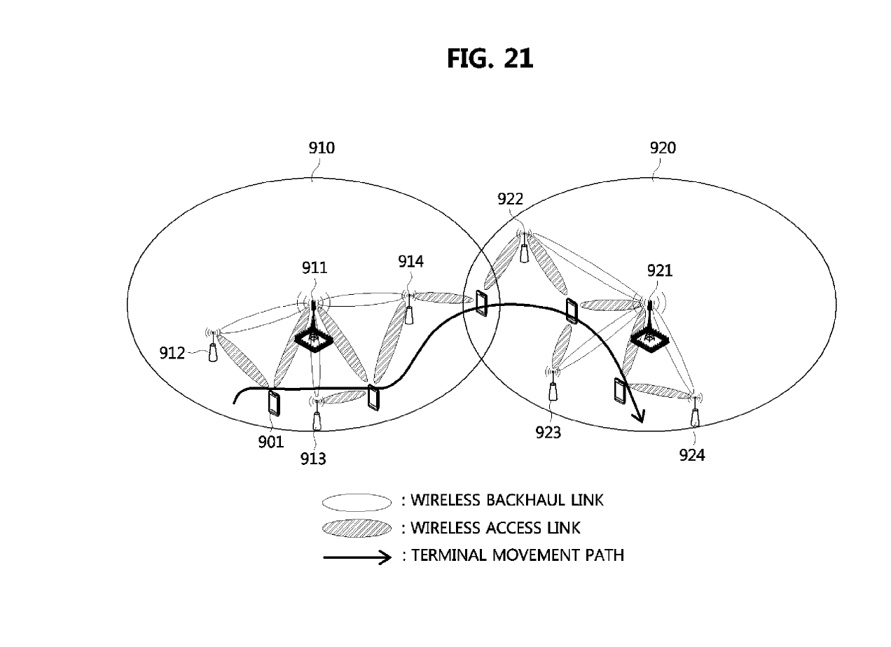

FIG. 21 is a conceptual diagram illustrating a handover method that is performed in the wireless communication system using the millimeter-wave frequency band according to the embodiment of the invention.

FIG. 21 exemplifies a low latency handover-distributed beam system (hereinafter referred to as “LH-DBS”) that is technology in which the central and/or relay base stations cooperate, dynamically form multiple beams for the terminal according to a movement path of the terminal, transmit different data or the same data, and handover between beams is available with very low latency (latency is maintained as 0 if possible).

In order to realize LH-DBS technology, multi-flow/inter-site MIMO based on distributed multi-beam should be supported, the terminal should perform a demodulation scheme that supports LH-DBS, and high speed handover (or high speed switching between beams) should be possible. In this case, well-known technology may be used as the demodulation scheme that supports LH-DBS.

In FIG. 21, a first cell 910 includes a first central base station 911 and a plurality of first relay base stations 912, 913, and 914 connected to the first central base station 911 via a wireless backhaul link, and a second cell 920 includes a second central base station 921 and a plurality of second relay base stations 922, 923, and 924 connected to the second central base station 921 via a wireless backhaul link. When a terminal 901 moves along a specific path in the wireless communication system using the millimeter-wave frequency band in which the first and second cells 910 and 920 are adjacently located, LH-DBS operations are illustrated in FIG. 21.

As illustrated in FIG. 21, when the terminal 901 is provided with a service in the first cell 910 and then moves to the second cell 920, the terminal 901 may receive and transmit data via a plurality of wireless access links made by the central base station and/or relay base stations according to a movement path, and available wireless access links (or beams) for the terminal change as the terminal moves.

As illustrated in FIG. 21, according to the invention, terminal mobility is supported by at least one beam so that it is possible to increase a signal to noise ratio (SNR) of a transmitting/receiving signal and to perform handover safely and quickly. Moreover, according to the invention, the central base station and relay base stations which are located in adjacent cells may perform high speed handover between beams using hierarchical hybrid scheduling. As a result, it is possible to blur a cell boundary.

An inter-beam high speed handover method according to the embodiment of the invention may be similar to a handover method using CoMP JP transmission in an LTE advanced system and macro diversity handover (MDHO) in WiMAX. However, the above conventional handover methods do not consider directional beams used in the central base station, relay base station, and/or terminal according to the invention, and do not support a multi-hop topology in the wireless communication environment using the millimeter-wave frequency band. In particular, as described above, since the number of beams that can be formed by the terminal at the same time may differ depending on terminal specifications, the number of transmitting/receiving devices that can be used at the same time in CoMP in LTE-Advanced and MDHO in WiMAX may be determined depending on terminal specifications. Therefore, there is a limitation of overall performance improvement.

Hereinafter, an LH-DBS method will be described in detail.

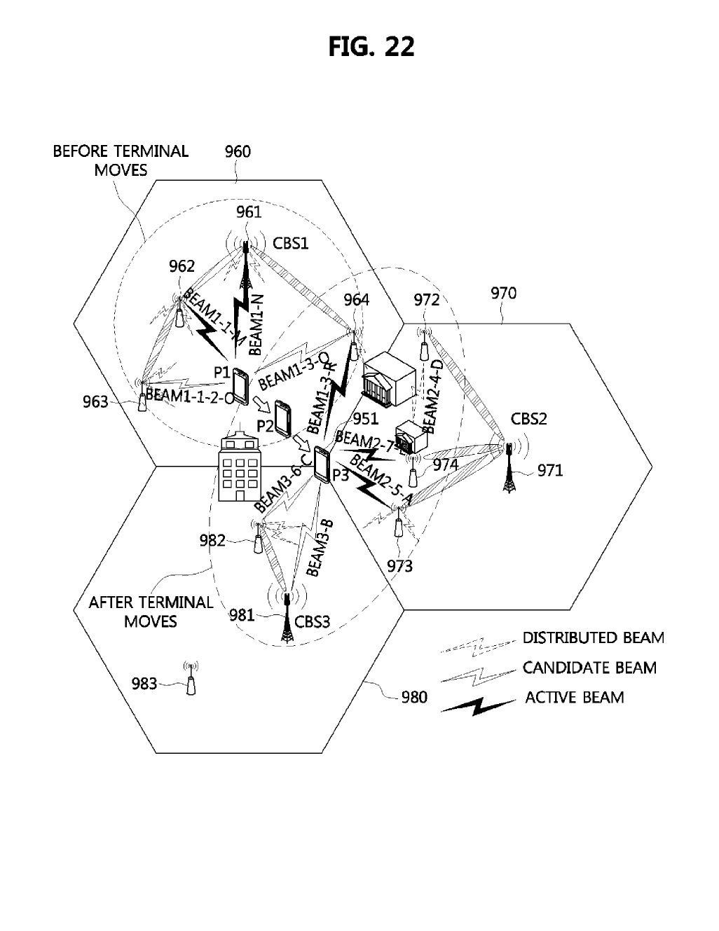

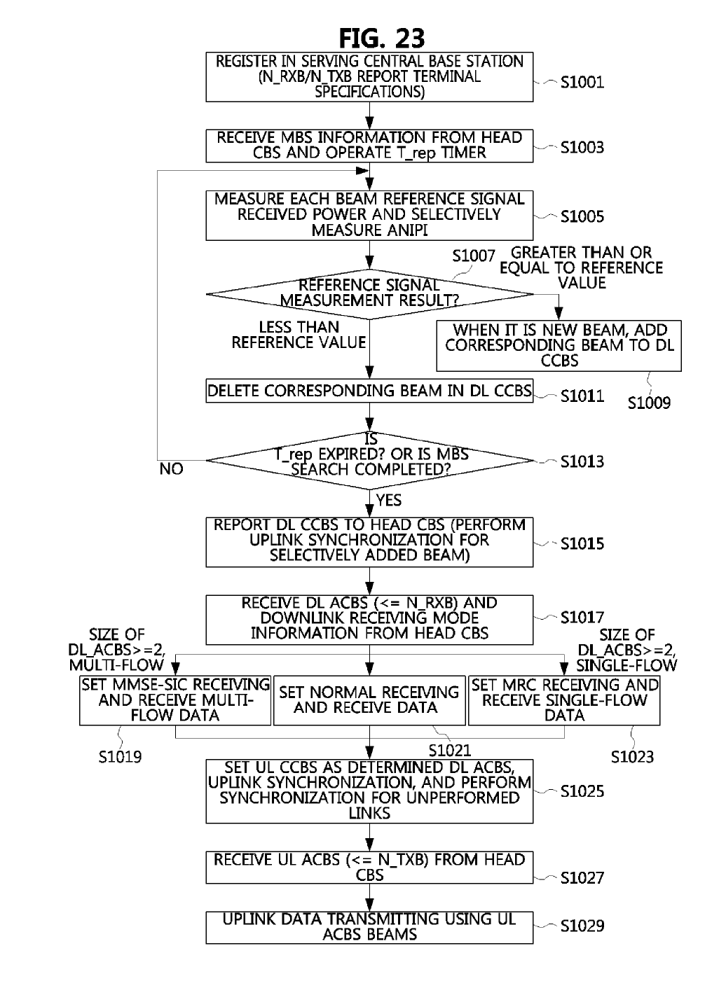

FIG. 22 is a conceptual diagram illustrating the handover method in more detail that is performed in the wireless communication system using the millimeter-wave frequency band according to the embodiment of the invention. FIG. 23 is a flowchart illustrating the handover method that is performed in the wireless communication system using the millimeter-wave frequency band according to the embodiment of the invention.

First, the terms used to explain operations of the LH-DBS method according to the embodiment of the invention will be defined.

A measurement beam set (hereinafter referred to as “MBS”) is information that is reported from a head CBS of the terminal to the terminal, and refers to a list of beams formed by adjacent central base station and/or relay base stations based on a place in which the terminal is located. The measurement beam set may be configured by the mobility controller/topology manager of the central base station.

A downlink candidate cooperated beam set (hereinafter referred to as “DL CCBS”) refers to a downlink cooperated beam candidate set, and may be a subset of MBS.

A downlink active cooperated beam set (hereinafter referred to as “DL ACBS”) refers to a set of beams that transmit data over a downlink according to a predetermined method in LH-DBS, and may be a subset of DL CCBS.

An uplink candidate cooperated beam set (hereinafter referred to as “UL CCBS”) refers to an uplink cooperated beam candidate set, may be the same as DL CCBS, and may perform uplink synchronization with corresponding beams.

An uplink active cooperated beam set (hereinafter referred to as “UL ACBS”) refers to a set of beams that transmit data over an uplink according to a predetermined method in LH-DBS, may be a subset of UL CCBS, and may refer to a set of beams in which a round-trip time (RTT) value with the terminal is satisfied.

N_RXB is the number of beams that can be received by the terminal at the same time, and it is assumed to be 2 in FIG. 22.

N_TXB is the number of beams that can be transmitted from the terminal at the same time, and it is assumed to be 2 in FIG. 22.

As illustrated in FIGS. 22 and 23, FIG. 22 exemplifies a logical set of beams for performing an LH-DBS function according to the embodiment of the invention. Candidate beams and active beams are configured before the terminal moves, and the candidate beams and active beams are changed as the terminal moves.

Table 1 shows beam sets according to terminal locations in the cellular network using the millimeter-wave frequency band illustrated in FIG. 22.

TABLE 1

| | Terminal | | Terminal |
|---|---|---|---|
| | location (P1) | Terminal location (P2) | location (P3) |
| MBS | . . . | . . . | . . . |
| | Beam1-n | Beam1-n | Beam1-n |
| | Beam1-1-m | Beam1-1-m | Beam1-1-m |
| | Beam1-1-2-o, . . . | Beam1-1-2-o, . . . | Beam1-1-2-o, . . . |
| | Beam1-3-q | Beam1-3-q | Beam1-3-q |
| | Beam1-3-r, . . . | Beam1-3-r, . . . | Beam1-3-r, . . . |
| | Beam2-7-e | Beam2-7-e | Beam2-7-e |
| | Beam2-5-a, . . . | Beam2-5-a, . . . | Beam2-5-a, . . . |
| | Beam3-b | Beam3-b | Beam3-b |
| | Beam3-6-c | Beam3-6-c | Beam3-6-c |
| | . . . | . . . | . . . |
| DL CCBS | Beam1-n | Beam1-n | Beam1-3-r |
| | Beam1-1-m | Beam1-1-m | Beam2-7-e |
| | Beam1-1-2-o | Beam1-1-2-o | Beam2-5-a |
| | Beam1-3-q | Beam1-3-q | Beam3-b |
| | | Beam2-5-a | Beam3-6-c |
| DL ACBS | Beam1-n | Beam1-n | Beam1-3-r |
| | Beam1-1-m | Beam2-5-a | Beam2-5-a |
| UL CCBS | DL CCBS | DL CCBS | DL CCBS |
| UL ACBS | DL ACBS | DL ACBS | DL ACBS |
| Head CBS | CBS1(961) | CBS1(961) | CBS1(961) |

As illustrated in FIG. 22, for example, when a terminal 951 is located in a first location P1 within a first cell 960, among candidate beams formed by a central base station (CBS1) 961 and a plurality of relay base stations 962, 963, and 964 in which the first cell 960 is located, the terminal 951 transmits and receives data using DL ACBS (Beam1-n and Beam1-1-m) formed by the central base station 961 and relay base station 962.

Then, when the terminal 951 moves to a second location P2 in the first cell 960, DL ACBS is changed to Beam1-n and Beam2-5-a formed by the central base station 961 and a relay base station 973. Moreover, when the terminal 951 moves from the second location P2 to a third location P3 that is a boundary point of the first cell 960, a second cell 970, and a third cell 980, among a plurality of candidate beams formed by the relay base stations 962, 963, and 964 of the first cell 960, relay base stations 972, 973, and 974 of the second cell 970, and relay base stations 982 and 983 and a central base station 981 of the third cell 980, DL ACBS and UL ACBS used for transmitting and receiving by the terminal 951 are changed to active beams (Beam1-3-r and Beam2-5-a) formed by the relay base station 964 of the first cell 960 and the relay base station 973 of the second cell 970.

Hereinafter, operations in which the LH-DBS function is performed according to the embodiment of the invention will be described with reference to FIGS. 22 and 23. The LH-DBS function illustrated in FIG. 23 will be performed by the terminal provided with a service in the communication system using the millimeter-wave frequency band according to the embodiment of the invention.

First, the terminal 951 registers in the serving central base station 961 (S1001). In this case, the terminal 951 may report N_RXB and N_TXB information as specifications of its own transmitting and receiving beams.

In FIGS. 22 and 23, as described above, after the terminal 951 registers in the serving central base station 961, it is assumed that the terminal 951 is provided with a downlink service using one beam (Beam1-n) of the central base station 961 and one beam (Beam1-1-m) of the relay base station 962 as DL ACBS, and that UL ACBS is the same as DL ACBS. Therefore, the central base station 961 serves as the head CBS.

Meanwhile, the terminal may also receive beams (Beam1-1-2-o and Beam1-3-q) from the relay base stations 963 and 964. Therefore, DL CCBS of the terminal may include Beam1-n, Beam1-1-m, Beam1-1-2-o, and Beam1-3-q.

The central base station 961 determines N_RXB reported by the terminal among DL CCBS of the terminal, a link state measured by the terminal, and traffic load states of base stations that form beams included in DL CCBS, and may determine DL ACBS of the terminal.

Meanwhile, there are three modes in which the terminal receives data from beams included in DL ACBS. Specifically, a single-flow cooperated receiving mode in which the same data is received from two or more beams included in DL ACBS, a multi-flow cooperated receiving mode in which different data is received from two or more beams included in DL ACBS, and a general receiving mode used in a case in which one beam is included in DL ACBS.

In FIG. 22, since DL ACBS includes two beams, the terminal may receive data using the single-flow cooperated receiving mode or multi-flow cooperated receiving mode.

The mobility controller/topology manager of the central base station 961 serving as the head CBS may configure MBS which is information on adjacent beams based on a location of the terminal 951, and report the configured MBS information to the terminal 951 using Beam1-n. Here, the central base station 961 may transmit the MBS information using an arbitrary beam among beams configuring DL ACBS. However, in general, since transmission reliability of a control message may be improved using a modulation and coding scheme (MCS) having high reliability, it is preferable that one beam be selected in terms of resource usage efficiency. One beam that delivers the control message is called a primary beam. While the embodiment of the invention describes an example in which the control message is delivered using the primary beam, the invention is not limited thereto. For example, the control message may be transmitted using beams included in DL ACBS.

As the central base station 961 transmits MBS to the terminal 951 using the primary beam, the terminal 951 receives the MBS information from the central base station 961 (S1003).

Based on the MBS information received from the central base station 961, the terminal 951 identifies beams corresponding to MBS by adjusting a weight vector of an antenna. Thus, the terminal 951 measures a preamble or reference signal received power (hereinafter referred to as “RSRP”) of each beam with respect to the identified beams and updates DL CCBS (S1005). In this case, the terminal 951 may also selectively measure an average noise plus interference power indicator (ANIPI) of wireless resources (for example, a frequency and/or time resource called a resource block (RB)) currently receiving through DL ACBS with respect to a newly added beam in DL CCBS, and may also measure RSRP of a different reference signal in the same direction. In general, mutually orthogonal reference signals are generated for each cell in the cellular network (for example, frequencies in which reference signals are transmitted may be different each other). A reference signal having the highest RSRP measured in one beam direction is a beam that can be added to DL CCBS. When RSRP of another reference signal is measured in the same direction, this signal may be determined as an interference signal source for the beam having the highest RSRP, and is called ANIPI_RS. Interference on the above resource block is called ANIPI_RB.

ANIPI is a parameter to determine how much interference signals exist in a beam to be added, and may be used as reference data when a mobility controller/topology manager of the central base station 961 determines DL ACBS later. That is, as a measured ANIPI is small, link quality is excellent.

While the terminal 951 measures RSRP of MBSs as described above, the terminal also measures RSRP of an existing DL CCBS. Here, based on a measurement result of DL CCBS, the terminal 951 may also delete beams failed to satisfy a predetermined criterion among existing beams from DL CCBS.

More specifically, the terminal 951 measures RSRP (or ANIPI) of beams included in MBS and/or existing DL CCBS, compares a measurement result with a predetermined reference value (S1007), and then adds a beam of which RSRP has received power (or ANIPI) greater than or equal to a predetermined reference value to DL CCBS (S1009), or deletes beams of which RSRP (or ANIPI) is less than the reference value among beams included in an existing DL CCBS from DL CCBS (S1011). While the embodiment of the invention describes an example in which DL CCBS is configured based on the reference value as described above, it is possible to configure DL CCBS by selecting maximum N (here, N is a design parameter) among measured RSRP values.

Meanwhile, whenever DL CCBS is changed, the terminal 951 may report the change to the mobility controller/topology manager of the central base station 961, or the terminal may report according to a predetermined period. Here, when the terminal 951 is configured such that the change of DL CCBS is reported according to the predetermined period, the terminal 951 may determine a report period using a timer (T_rep). That is, in operation S1003 of FIG. 23, the terminal 951 operates the timer (T_rep), and then determines whether the timer is expired in operation S1013. When it is determined that the timer is expired, the serving central base station 961 may be reported with DL CCBS (S1015).

In operation S1015, the terminal 951 moving to the third location P3 configures DL CCBS (in FIG. 15, Beam1-3-r, Beam2-5-a, Beam2-7-e, Beam3-b, and Beam3-6-c) based on the RSRP measurement result, and then reports the configured DL CCBS information to the mobility controller/topology manager of the central base station 961 using the primary beam (Beam1-n). At the same time, when a beam is added, it is possible to selectively perform uplink synchronization using the beam.

Meanwhile, the mobility controller/topology manager of the central base station 961 compares the DL CCBS information reported from the terminal 951 and a previously stored DL CCBS, examines a change of DL CCBS, allows a corresponding central base station and/or relay base stations to delete resources associated with the terminal 951 with respect to beams deleted in DL CCBS based on an examination result, and queries whether the terminal 951 is accommodated with respect to newly added beams in DL CCBS to the mobility controller/topology manager of a corresponding central base station and/or relay base station.

The central base station 961 extracts beams that can accommodate the terminal 951 from DL CCBS reported from the terminal 951 as described above, configures as many DL is ACBS as less than or equal to N_RXB value of the terminal 951 based on reference signal measurement values and ANIPI values of the extracted beams, and then transmits the configured DL ACBS information to the terminal 951. For example, in FIG. 22, DL ACBS may include Beam1-3-r and Beam2-5-a. In this case, Beam1-3-r may be a next primary beam as the terminal 951 moves. The DL ACBS information may be transmitted using only Beam1-n serving as a current primary beam or may also be transmitted using Beam2-5-a to the terminal more safely. In this case, when the primary beam is changed from Beam1-n to Beam1-3-r, the head CBS may also give signaling about the change to the terminal, and report a downlink receiving mode of the terminal.

The terminal 951 receives the DL ACBS information and downlink receiving mode information of the terminal as configured above from the head CBS (S1017).

Here, a downlink receiving method of the terminal may be any one of the multi-flow cooperated receiving mode (S1019), general receiving mode (S1019), and single-flow cooperated receiving mode (S1021). The terminal receives downlink data based on received downlink receiving mode information. For example, the terminal performs MMSE-SIC reception setting when the downlink receiving method of the terminal is the multi-flow cooperated receiving mode. When the downlink receiving method of the terminal is the general receiving mode, the terminal performs general data reception setting. When the downlink receiving method of the terminal is the single-flow cooperated receiving mode, the terminal performs MRC reception setting and then receives downlink data.

Meanwhile, the terminal 951 may perform uplink synchronization for DL CCBS beams at any time. Moreover, when the DL ACBS information is received from the central base station, the terminal 951 sets DL CCBS as DL ACBS, and performs uplink synchronization for beams included in DL ACBS preferentially (S1025). In this case, when uplink synchronization for DL CCBS is performed first, the terminal 951 may perform synchronization for beams for which uplink synchronization is not performed among beams is included in the received DL ACBS.

As described above, when the terminal 951 carries out uplink synchronization, a mobility controller/topology manager of a corresponding central base station and/or relay base station may report round-trip time values obtained by uplink synchronization operations of the terminal 951 to the mobility controller/topology manager of the central base station 961.

The mobility controller/topology manager of the head CBS 961 may determine an optimal UL ACBS from UL CCBS based on the reported round-trip time values as described above and transmit the optimal UL ACBS to the terminal 951 through current DL ACBSs, and the terminal 951 may receive UL ACBS information from the head CBS 961 and update UL ACBS based on the received information (S1027). In this case, the UL ACBS may have a value less than or equal to N_TXB reported from the terminal 951.

Then, the terminal may transmit uplink data using beams included in the UL ACBS (S1029).

The DL ACBS and UL ACBS as configured above may have the same or different value. In downlink receiving using DL ACBS in the terminal 951, a diversity scheme such as maximal ratio combining (MRC) is used in single-flow cooperated receiving so that a downlink receiving effect having higher reliability may be obtained. In multi-flow cooperated receiving, an interference removing receiver module such as minimum mean square error-successive interference cancellation (MMSE-SIC) is used to effectively receive different data so that receiving frequency efficiency may be improved. Transmission from the terminal 951 using UL ACBS passes different base stations, and receiving efficiency may be improved using various techniques such as selection diversity in the head CBS.

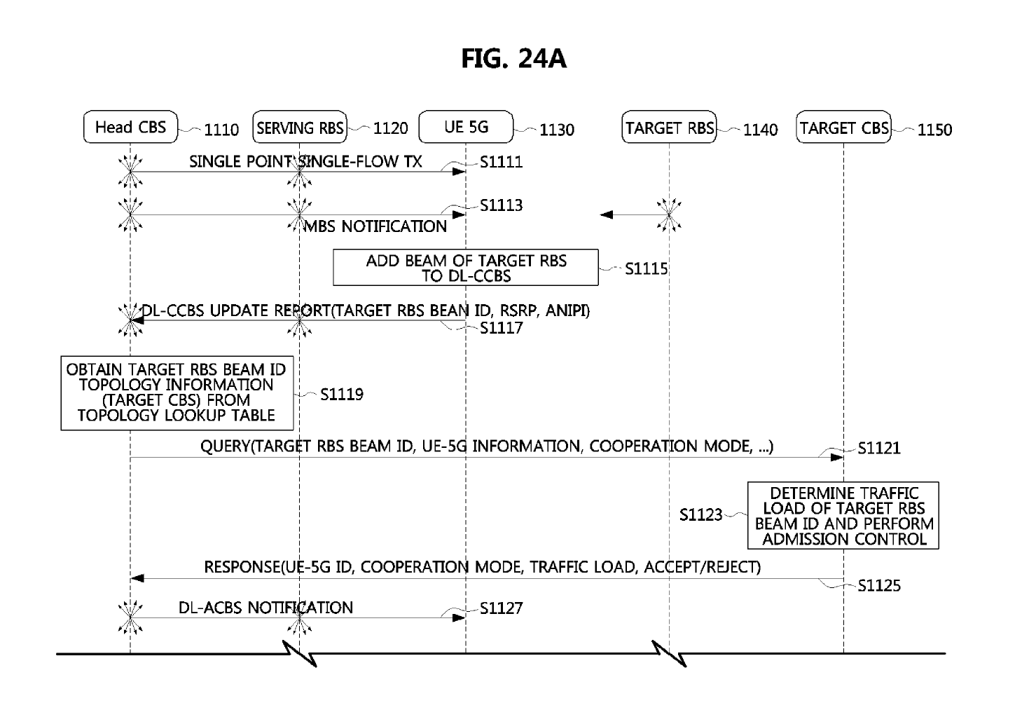

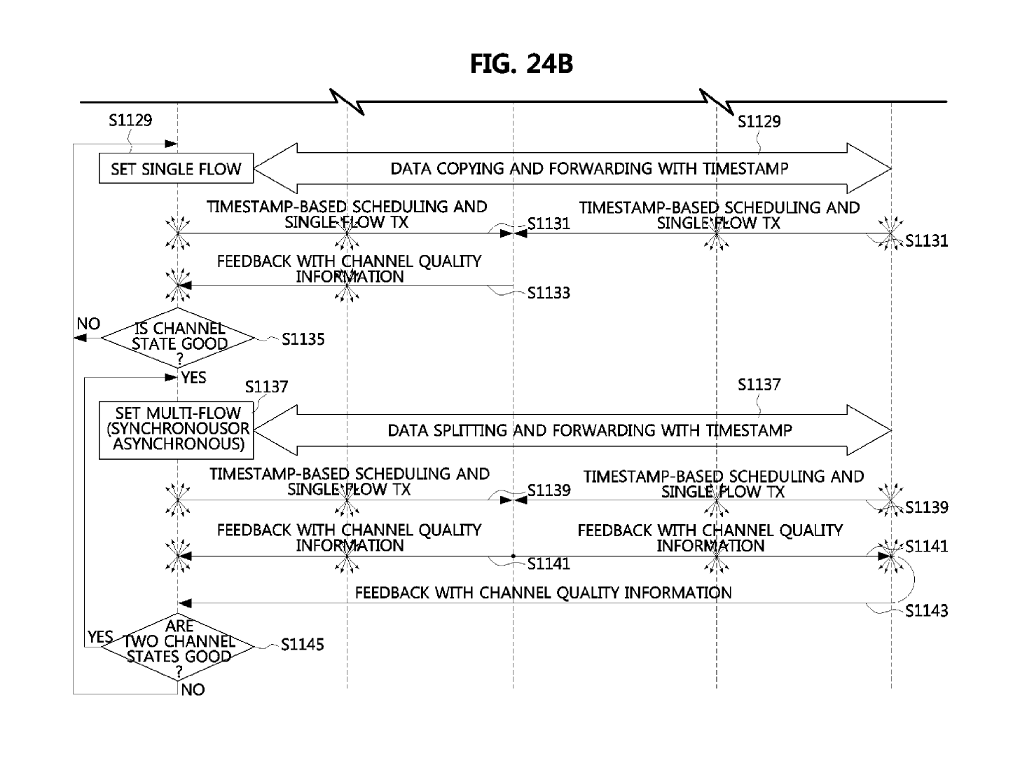

FIGS. 24A and 24B are sequence diagrams illustrating the handover method that is performed in the wireless communication system using the millimeter-wave frequency band according to the embodiment of the invention, and illustrate interaction between the base station and terminal (mobile station).

In FIG. 24, while a mobile station 1130 communicates with a central base station (head CBS) 1110 using a beam provided by a relay base station (serving RBS) 1120 (S1111), when a beam formed from another relay base station (target RBS) 1140, LH-DBS operations start.

The mobile station 1130 receives MBS information that is periodically transmitted from the head CBS 1110 through the serving RBS 1120 (S1113), and scans beams transmitted from adjacent base stations based on the received MBS information. Here, the MBS information is determined by the head CBS 1110 based on location information of the mobile station 1130, includes beam information of adjacent central/relay base stations that provide beams around the mobile station 1130, and may further include, for example, handover preamble information and random access channel (RACH) periodicity of adjacent beams necessary for improving handover performance of the mobile station 1130. Using these operations, the mobile station 1130 that has identified a beam of the target RBS 1140 determines whether the beam is added to DL-CCBS using reference signal strength measurement of a corresponding beam as described in FIG. 23. In FIG. 24, it is assumed that the corresponding beam is added to the DL-CCBS (S1115).

In addition, as described in FIG. 23, the mobile station 1130 also measures ANIPI of the corresponding beam. As described above, the mobile station 1130 that adds one beam to the DL-CCBS reports the updated DL-CCBS to the head CBS 1110 using a wireless backhaul beam and wireless access beam provided by the serving RBS 1120 (S1117). In this case, identifier information (target RBS beam ID) of the added beam and measured RSRP/ANIPI information are transmitted together.

The head CBS 1110 may manage a topology lookup table. The topology lookup table records all central/relay base stations around the head CBS 1110 and beam information managed by the all central/relay base stations. The target RBS 1140 and target CBS 1150 information may be easily obtained from the target RBS beam ID information reported by the mobile station 1130 (S1119). Here, the target RBS 1140 is a relay base station that manages target RBS beam IDs of added beams, and the target CBS 1150 is an adjacent central base station that manages the target RBS 1140.

In order to check whether terminal data can be transmitted using the beam reported from the mobile station 1130, the head CBS 1110 transmits a query message to the target CBS 1150. The query message may generally include, for example, a target RBS beam ID, terminal information, and cooperated mode information (S1121). In this case, the terminal information may include all information that is used for the base station to support the terminal, for example, a terminal traffic volume, and a cooperated mode is an indicator that represents single-flow transmission and multi-flow transmission as described below.

The target CBS 1150 that has received the query information may identify the target RBS 1140 serving as the relay base station that provides a corresponding beam using the target RBS beam ID information, and determines whether the terminal can be supported through load state determination of the target RBS 1140. In this case, the target RBS load state may be determined based on information that is periodically reported from the target RBS 1140 to the target CBS 1150. The target CBS 1150 directly requests the load state from the target RBS 1140 and receives a response thereof so that it is possible to determine the load state in real time.

After the target CBS 1150 determines (admission control) whether terminal traffic may be supported with the target RBS beam ID based on the load state (S1123), the target CBS provides a response to the head CBS 1110 as a form of a response message. This response message includes acceptance or not, and traffic load state information (including load states of a wireless access beam and wireless backhaul beam) (S1125).

For convenience of description, FIG. 24 exemplifies a case in which a single beam is added to DL CCBS. However, in general, a plurality of beams may be added to DL CCBS. When the plurality of beams are added to DL CCBS, operations of adding one beam as described above are respectively performed for the plurality of beams.

The head CBS 1110 is reported with a traffic load state and terminal acceptance intention from adjacent base stations with respect to each beam that is added to DL-CCBS by the mobile station 1130, and determines optimal cooperated base station beams based on the reported information. In this case, with respect to beams included in DL-CCBS, the head CBS 1110 considers only beams to which terminal acceptance intention is expressed from adjacent base stations. In this case, reference signal receive quality (RSRQ), ANIPI_RS, ANIPI_RB, and RSRP measured by the terminal, and a traffic load level (TLL) reported from an adjacent base station may be considered together. The head CBS 1110 may determine DL ACBS using Equation 4. Equation 4 is applied to each beam included in DL CCBS. As a resulting value has a greater value, a corresponding beam may be preferentially used in cooperated transmission.

α₁×RSRP+α₂×RSRQ−β₁×ANIPI_{RS}−β₂×ANIPI_{RB}+γ×TLL Equation 4

In Equation 4, α₁, α₂, β₁, β₂, γ represent a measurement weight for each parameter, and may be determined by a system designer. The measurement weight may determine measurement value importance. When a specific weight is set to 0, a corresponding measurement value may be ignored.

The head CBS 1110 selects one beam added through the operations as described above, determines the beam as DL-ACBS with an existing beam, and the reports the result to the mobile station 1130 (S1127). Through these operations, it is possible to simultaneously transmit traffic to the mobile station 1130 using two beams included in the DL-ACBS.

When cooperated transmission is performed using beams included in the DL-ACBS, the invention considers two methods, one is single flow cooperated transmission and another is multi-flow cooperated transmission.

In case of single flow cooperated transmission, the same data is transmitted using a plurality of beams included in DL-ACBS so that the terminal may have various diversity effects. In this case, in general, the terminal may obtain optimal efficiency when MRC method is used. However, in case of single flow cooperated transmission, since the same data is transmitted over two or more wireless backhaul links, resource efficiency in the wireless backhaul link may be decreased.

On the other hand, in case of multi-flow cooperated transmission, terminal traffic is divided into flows corresponding to a size of DL-ACBS, and each divided flow is transmitted using each beam included in DL-ACBS.

Both of the two cooperated transmissions use the same resource in order to increase resource efficiency of the wireless access link. In particular, in terms of the terminal, it is possible to minimize mutual interference and improve processing efficiency by enabling signals using different beams to arrive within a cyclic prefix (CP).

Substantially, in case of multi-traffic cooperated transmission, when the terminal supports specifications capable of processing each flow independently, synchronization between packet transmissions included in each flow is unnecessary in the central/relay base station. In this case, since using different resources between different flows is allowed in the wireless access link, synchronization is inefficient in terms of wireless access link resource usage. In case of multi-traffic cooperated transmission, when transmission is performed such that all multi-path signals finally transmitted to the terminal are received in a cyclic prefix (CP), it is called “synchronous multi-flow cooperated transmission,” and when synchronization transmission between individual flows is unnecessary, it is called “asynchronous multi-flow cooperated transmission.” The two cases may be included in the multi-flow cooperated transmission in the invention. However, for convenience of description, FIG. 24 exemplifies only synchronous multi-flow cooperated transmission.

When the number of beams included in DL-ACBS is two or more, a start mode of is cooperated transmission may be single flow or multi-flow cooperated transmission. However, the mode generally starts with single flow cooperated transmission.

In case of single flow cooperated transmission, the terminal processes signals received from two or more beams using various diversity techniques so that more reliable signal recovery than a case of receiving signals from one beam may be possible. In general, a beam overlapping area is the most distant area from base stations, interference between beams occurs, and a channel state is relatively poor. Moreover, since channel information for each beam is not secured, it is preferable that the mode be started with single flow cooperated transmission for more reliable communication. To this end, the head CBS 1110 copies packets to be transmitted to the mobile station 1130, transmits the copied packets to the target CBS 1150, and transmits transmission scheduling information together such that the same packets are finally transmitted to the mobile station 1130 at the same time (that is, within a CP) (S1129).

That is, in case of single flow cooperated transmission, the head CBS 1110 is operated as a central scheduler that determines scheduling. When scheduling information and data are transmitted, lower relay base stations including the target CBS 1150 perform scheduling of corresponding packets based on the scheduling information such that the packets are finally transmitted to the mobile station 1130 at the same time (S1131). In general, the scheduling information may be transmitted in a type of a timestamp that records a time to be transmitted. Needless to say, a timestamp value is used on the assumption that distributed base stations are synchronized, and various synchronization methods may be used. In this way, the terminal that receives packets through single flow cooperated transmission may improve receiving efficiency using various diversity techniques, and the MRC method may be generally used.

The mobile station 1130 transmits channel information to the head CBS 1110 (S1133) so that transmission adaptive to a channel state may be possible. Such channel state is feedback may be transmitted over beams in which single flow cooperated transmission is performed. However, the feedback needs to be transmitted to the head CBS 1110 finally. It is preferable that the feedback be transmitted using a beam to improve wireless resource efficiency.

As described above, the head CBS 1110 that schedules single flow cooperated transmission may receive channel state feedback information from the mobile station 1130, and determines a channel state (S1135). In this case, when it is determined that the channel state is good, the head CBS 1110 may change the mode to a multi-flow cooperated transmission mode in which the wireless backhaul resource and wireless access resource may be more effectively used (S1137).

Unlike the single flow case, in case of the multi-flow cooperated transmission mode, adaptive modulation and coding (AMC) suitable for channel states of a plurality of beams over which packets are transmitted may be independently applied. Moreover, in case of asynchronous cooperated transmission, since the target CBS and relay base station may independently schedule based on the timestamp (S1139), it is also possible to transmit channel information over individual beams as illustrated in FIG. 24 (S1141).

However, in case of synchronous cooperated transmission, like single flow cooperated transmission, since the head CBS 1110 manages scheduling, channel state information needs to be transmitted to the head CBS 1110. In case of synchronous multi-flow cooperated transmission, channel state information of individual beams may also be transmitted using a beam (S1143).

The head CBS 1110 determines a multi-flow channel state based on the channel state feedback information from the mobile station 1130 (S1145). When it is determined that the channel state is poor, the mode may also be changed to the single flow cooperated transmission mode again.

Hereinafter, a multi-mode multi-access method, that can remove or reduce is interference between adjacent beams and apply an optimal multi-access method appropriate for terminal conditions in the wireless communication system using the millimeter-wave frequency band according to the embodiment of the invention, will be described.

Examples of the considered multi-access method in the invention include an orthogonal frequency division multiple access (OFDMA), multi-carrier code division multiple access (MC-CDMA), non-orthogonal multiple access (NOMA), and filter bank multicarrier (FBMC). In this case, as the NOMA method, an interleave-division multiple access (IDMA) method and a hierarchical modulation method used in, for example, DVB-T and MediaFLO, may be applied.

The multi-mode multi-access method applied in the wireless communication system using the millimeter-wave frequency band according to the embodiment of the invention may be configured by a combination of the above multi-access methods. For example, the technological scope of the invention may also include a case in which FBMC and MC-CDMA are applied in NOMA.

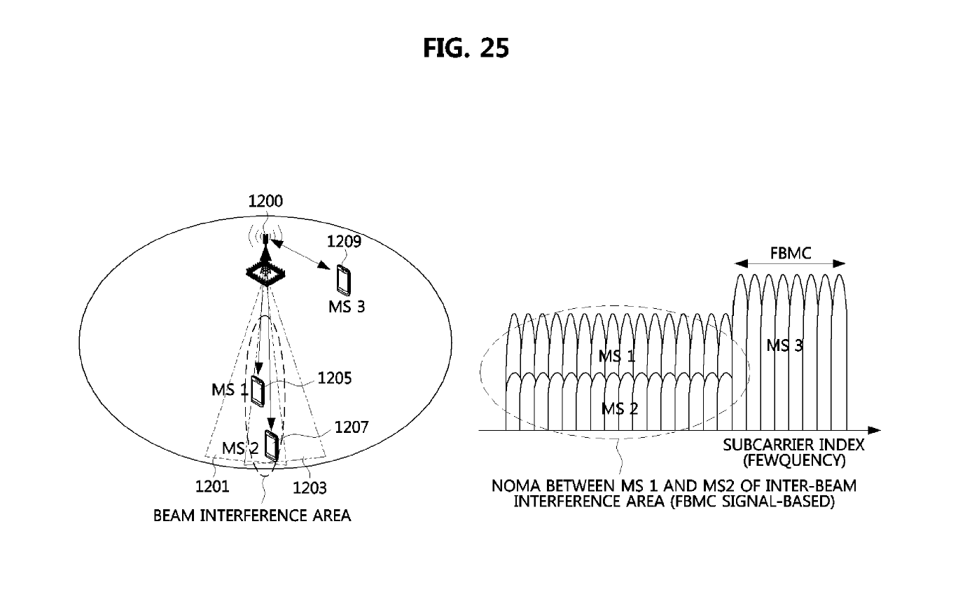

FIG. 25 is a conceptual diagram illustrating an example of the multi-mode multi-access method that can be applied in the wireless communication system using the millimeter-wave frequency band according to the embodiment of the invention.

As illustrated in FIG. 25, when two beams 1201 and 1203 are generated from a central base station (or relay base station) 1200, first and second terminals 1205 and 1207 are located in an inter-beam interference area in which the two beams 1201 and 1203 overlap, and a third terminal 1209 is located in an area other than a service area covered by the two beams, the first and second terminals 1205 and 1207 may apply the NOMA method in the same frequency band, and the third terminal 1209 may apply the FBMC method in a different frequency band from the frequency band assigned to the first and second terminals 1205 and 1207.

According to the communication device and communication method using the is millimeter-wave frequency band as described above, there are provided the device, communication system, and communication method to build a new mobile communication network (or cellular network) using the millimeter-wave frequency band.

Therefore, it is possible to accommodate explosively growing mobile traffic. In particular, in order to maximize space recycling, the invention provides the method and device that can form a plurality of beams in a base station. As a result, it is possible to address the shadowing problem due to directionality of signals having the millimeter-wave frequency band.

Moreover, the high speed handover method for supporting terminal mobility is provided in the communication system using the millimeter-wave frequency band according to the invention. Therefore, it is possible to provide seamless services and guarantee quality of service.

While example embodiments of the present invention and their advantages have been described in detail, it should be understood that various changes, substitutions, and alterations may be made to the example embodiments without departing from the scope of the invention as defined by the following claims.

Reference Numerals

| | |
|---|---|
| 110: antenna | 111: antenna element |
| 120: antenna | 121: antenna element |
| 125: non-uniformed slot | 130 and 140: antenna |
| 150: patch array antenna | 151: linear antenna array module |
| 160: patch array antenna | 161: circular antenna array module |
| 170: antenna | 171: beam |
| 173: building or obstacle | 210: central base station (CBS) |
| 221 and 223: relay base station (RBS) | 230: mobile station (MS) |
| 241: wireless backhaul beam | 243: wireless access beam |
| 310: antenna | 311 and 313: antenna element |
| 350: terminal | 360: patch array antenna |
| 361: patch antenna element | 410: antenna |
| 420: analog beamforming unit | 430: RF signal processing unit |
| 431a: low noise amplifier | 431b: digital up converter |
| 432a: local oscillator | 432b: digital-to-analog converter |
| 433a: mixer | 433b: intermediate frequency amplifier |
| 434a and 434b: band pass filter | 435a: intermediate frequency amplifier |
| 435b: mixer | 436a: analog-to-digital converter |
| 436b: amplifier | 437a: digital down converter |
| 440: digital signal processing unit | 450: analog beamforming control unit |
| 460: calibration detecting unit | 510: antenna module |
| 520: RF transceiver | 530: physical layer processing unit |
| 540: MAC layer processing unit | 550: beam scheduling unit |
| 551: central scheduler | 553: beam scheduler |
| 555: input queue | 557: output queue |
| 560: core network interface unit | 570: inter-central base station interface unit |
| 580: mobility controller/topology manager | 610: first beam (Beam#1) |
| 620: second beam (Beam#2) | 630: third beam (Beam#3) |
| 710: antenna module | 720: RF transceiver |
| 730: physical layer processing unit | 740: MAC layer processing unit |
| 750: beam scheduling unit | 751: central scheduler |
| 753: beam scheduler | 755: input queue |
| 757: output queue | 760: wireless backhaul interface unit |
| 780: mobility controller/topology manager | 801: terminal |
| 810: central base station | 811: central base station |
| 820, 821, and 830: relay base station | 901: terminal |
| 910: first cell | 911: first central base station |
| 912, 913, and 914: first relay base station | |
| 920: second cell | 921: second central base station |
| 922, 923, and 924: second relay base station | |
| 951: terminal | 960: first cell |
| 961: central base station | 962, 963, and 964: relay base station |
| 970: second cell | 971: central base station |
| 972 and 973: relay base station | 980: third cell |
| 981: central base station | 982: relay base station |
| 983: relay base station | 1110: head CBS |
| 1120: serving RBS | 1130: MS |
| 1140: Target RBS | 1150: target CBS |
| 1200: central base station | 1201 and 1203: beam |
| 1205: first terminal | 1207: second terminal |
| 1209: third terminal | |

What is claimed is:

1. A wireless communication device using a millimeter-wave frequency band comprising:
a beam scheduling unit configured to schedule uplink and downlink beams corresponding to movement of a terminal;
a core network interface unit configured to transmit data provided from the beam scheduling unit to a core network, and to provide data received from the core network to the beam scheduling unit;
a mobility management unit configured to configure an uplink and downlink beam set based on inter-beam interference information provided from the beam scheduling unit; and
an inter-base station interface unit configured to exchange a control message with another base station under control of the mobility management unit.

2. The device of claim 1, wherein the beam scheduling unit includes a central scheduler and at least one beam scheduler connected to the central scheduler,
the central scheduler distributes packets input from the core network through the core network interface unit to the at least one beam scheduler, schedules the packets provided from the at least one beam scheduler, and transmits the packets to the core network through the core network interface unit, and
the at least one beam scheduler schedules based on scheduling information provided from the central scheduler.

3. The device of claim 2, wherein the at least one beam scheduler receives location information of at least one terminal from the at least one terminal, reports the received location information of the at least one terminal to the central scheduler, and then schedules resources for the at least one terminal based on scheduling information provided from the central scheduler.

4. The device of claim 3, wherein the central scheduler obtains information on a terminal located in an inter-beam overlapping area based on the location information of the at least one terminal, and schedules based on the obtained terminal information such that inter-beam interference is minimized.

5. The device of claim 2, wherein, when at least two base stations cooperate to transmit downlink packets to the terminal, the central scheduler schedules a transmission time of packets, and then transmits scheduling information to the at least one beam scheduler and another base station.

6. The device of claim 1, wherein the mobility management unit configures a measurement beam set to be measured by the terminal based on location information of the terminal provided from the beam scheduling unit, and reports the configured measurement beam set information to the terminal.

7. The device of claim 1, wherein the mobility management unit determines a cooperated beam set that provides downlink beams to the terminal based on the inter-beam interference information.

8. The device of claim 1, wherein the mobility management unit compares a candidate cooperated beam set provided by the terminal and a pre-stored candidate cooperated beam set, determines a change of the candidate cooperated beam set, and then, when there is a deleted beam in the pre-stored candidate cooperated set, requests deletion of resources associated with the deleted beam from a base station that forms the deleted beam.

9. The device of claim 1, wherein the mobility management unit obtains round-trip time information obtained through terminal uplink synchronization operations from at least one other base station through the inter-base station interface unit, and determines a cooperated beam set for uplink transmission of the terminal based on the obtained round-trip time information.

10. A wireless communication device using a millimeter-wave frequency band comprising:
a beam scheduling unit configured to schedule a beam for accessing of a terminal;
a wireless backhaul interface unit configured to communicate with least one other base station under control of the beam scheduling unit; and
a mobility management unit configured to deliver information provided from the terminal to another base station through the wireless backhaul interface unit.

11. The device of claim 10, wherein the beam scheduling unit includes a central scheduler and at least one beam scheduler connected to the central scheduler,
the central scheduler controls scheduling of the at least one beam scheduler, and
the at least one beam scheduling unit respectively provides an access beam for at least one terminal under control of the central scheduler.

12. The device of claim 10, wherein the mobility management unit receives location information from at least one terminal, and delivers the information to another base station through the wireless backhaul interface unit.

13. The device of claim 10, wherein the mobility management unit delivers information on a downlink candidate cooperated beam set provided from at least one terminal to another base station through the wireless backhaul interface unit, and delivers round-trip time values of the at least one terminal to the another base station.

14. A wireless communication method using a millimeter-wave frequency band comprising:
obtaining location information of at least one terminal;
obtaining information on a terminal located in an inter-beam overlapping area based on the obtained location information; and
scheduling based on information on the terminal located in the obtained inter-beam overlapping area such that inter-beam interference is minimized.

15. The method of claim 14, wherein in the obtaining of location information of the at least one terminal, beam identifier information for at least one beam that can be received by the at least one terminal is respectively received from the at least one terminal.

16. The method of claim 14, wherein in the obtaining of location information of the at least one terminal, inter-beam interference information is received from the at least one terminal.

17. The method of claim 14, wherein in the scheduling for minimizing the inter-beam interference, different frequency bands are assigned to an overlapping beam area and a non-overlapping beam area in consideration of the inter-beam overlapping area, and a frequency band assigned to the overlapping beam area is changed according to location of at least one terminal and resource allocation information of the at least one terminal.

18. A wireless communication method using a millimeter-wave frequency band that is performed in a terminal using the millimeter-wave frequency band, the method comprising:
registering transmitting and receiving capability information in a base station;
measuring received power of each beam included in a beam set based on information on the beam set provided from the base station;
updating a downlink candidate cooperated beam set based on the received power measurement result of each beam, and then reporting the updated downlink candidate cooperated beam set to the base station; and
performing uplink synchronization based on a downlink active cooperated beam set provided from the base station.

19. The method of claim 18, wherein in the registering of the transmitting and receiving capability information in the base station, information on the number of beams that can be simultaneously received by the terminal and the number of beams that can be simultaneously transmitted from the terminal is reported to the base station.

20. The method of claim 18, wherein the performing of the uplink synchronization includes:
setting the downlink active cooperated beam set provided from the base station as an uplink active cooperated beam set; and
performing uplink synchronization for beams included in the uplink active cooperated beam set.
